(19) United States
(12) Patent Application Publication
(10) Pub. No.: US 2013/0187561 A1
(43) Pub. Date: Jul. 25, 2013

(54) Circuit Arrangement for Operating at Least Two Semiconductor Light Sources

(71) Applicants: Felix Franck, Munich (DE); Bernhard Siessegger, Danvers, MA (US)

(72) Inventors: Felix Franck, Munich (DE); Bernhard Siessegger, Danvers, MA (US)

(21) Appl. No.: 13/876,989

(22) PCT Filed: Sep. 23, 2011
(86) PCT No.: PCT/EP11/66606

§ 371 Date: Mar. 29, 2013

(30) Foreign Application Priority Data
Sep. 29, 2010 (DE) 10 2010 041 632.0

(51) Int. Cl. H05B 37/02

(52) U.S. Cl. CPC H05B 37/02
USPC 315/201

(57) ABSTRACT

A circuit arrangement for operating at least two semiconductor light sources, having an electrical energy converter comprising at least one switch; at least two operating sections, each having a rectifier with an input terminal, output terminal and reference potential. Each rectifier contains a single rectifier diode. The operating sections are coupled to the electrical energy converter. At least one common mode choke is connected between the switch and the at least two rectifiers. At least two semiconductor light sources are each connected between the output terminal of the associated rectifier and the reference potential thereof. The converter is a resonant converter having a resonant cell. A resonant capacitor is connected in parallel with each of the switches encompassed by the converter topology and to each rectifier diode encompassed by the converter topology. The leakage inductance of the common mode choke is used as the resonant.

### TECHNICAL FIELD

The invention relates to a circuit arrangement for operating at least two semiconductor light sources, said semiconductor light sources being operated in different operating sections and with the same current.

### BACKGROUND

The invention relates to a circuit arrangement for operating at least two semiconductor light sources as claimed in the main claim.

Current balancing via common mode chokes (current-compensated inductors) is known from the prior art, see e.g. EP 1788 850 B1 of the Applicant. This discloses a circuit arrangement in which a plurality of common mode chokes are interleaved in a cascade connection. For n operating sections, n−1 common mode chokes are required.

US 7408308B2 likewise discloses a circuit arrangement which, by means of cascaded common mode chokes, achieves current balancing of the operating sections connected to the common mode chokes.

EP 1 286 572 A2 likewise discloses a circuit arrangement for balancing the currents in fluorescent lamps using a common mode choke for that purpose.

However, the disadvantage of these known circuits is that the current balancing measuring are incorporated into an existing circuit, thereby incurring additional component costs. Due to the additional components, this makes the product larger and more expensive.

The publication Baddela, S. M.; Zinger, D. S. “Parallel connected LEDs operated at high frequency to improve current sharing”, Conference Record of the IEEE Industry Applications Conference, 39th IAS Annual Meeting, 2004, 3-7 Oct. 2004, pp. 1677-1681, Vol. 3 describes balancing of LED currents using capacitors connected in series with rectifiers. Here, however, the capacitive reactance of the capacitors is used, and this is frequency dependent. This is disadvantageous in that in various applications the operating frequency of the semiconductor light sources cannot be fixed because of particular constraints.

In all these applications, the voltage converters used are either hard-switching or employ simple ZVS (zero voltage switching). This has the disadvantage of poorer efficiency.

### OBJECT

The object of the invention is to specify a circuit arrangement for operating at least two semiconductor light sources which is no longer subject to the above mentioned disadvantages.

### SUMMARY

This object is achieved according to the invention by a circuit arrangement for operating at least two semiconductor light sources, having:
an electrical energy converter, comprising
at least one switch, wherein
the electrical energy converter outputs a pulsating DC voltage or an AC voltage,
at least two operating sections (strings), each of which has a unidirectionally blocking or short-circuiting rectifier having an input terminal, an output terminal and a reference potential, wherein the operating sections are coupled to the electrical energy converter,
at least one common mode choke, wherein the common mode choke is connected between the switch and the at least two rectifiers,
at least two semiconductor light sources which are each connected between the output terminal of the associated rectifier and the reference potential thereof, wherein the electrical energy converter is designed as a resonant converter having a resonant cell, and the leakage inductance of the common mode choke is used as the resonant inductance of said resonant cell. This measure provides saving in terms of component costs and space requirement, and the converter operates at high efficiency, thereby enabling the size to be reduced still further.

In the resonant cell, the leakage inductance of the common mode choke is preferably connected in series with at least one capacitor. Said capacitor is preferably connected to the reference potential. This measure enables a multiresonant operating mode to be achieved.

In one embodiment, the electrical energy converter is a class E converter. This is a simple, efficient converter topology for high frequencies.

In another embodiment, the electrical energy converter is a half-bridge converter. This converter topology can also be used for low frequencies and operates with high efficiency. However, two switches are required, one of which is a so-called high-side switch whose reference potential may at times deviate significantly from that of the second switch.

In another preferred embodiment, the electrical energy converter is a multiresonant cell converter which, similarly to the above class E converter, is characterized in that it only has a single active switch on its input side. Each such converter apart from the class E converter is also known as a single-switch DC/DC converter. This cell converter operates very efficiently due to the resonant mode of operation. The cell converter is available in step-down (buck), step-up (boost) or step-up and step-down (buck-boost, Ćuk, Zeta, SEPIC) designs.

A resonant capacitor is preferably connected in parallel with each power semiconductor incorporated in the converter topology. This achieves considerable soft switching, so that the power semiconductor can operate in ZVS mode, i.e. with zero voltage. Such converters are generally known as multiresonant converters operating in dual-ZVS mode.

In contrast to the non-resonant or hard-switching single-switch DC/DC converters whose active semiconductor switch is usually controlled using fixed-frequency or on-time oriented PWM, a multiresonant cell converter requires special state-dependent and variable-frequency PWM control of its active switch. The voltage across the active switch is observed, and the switch is only turned on again after the last turn-off process when its voltage becomes zero again for the first time or shows a minimum for the first time.

The resonant capacitors in parallel with the diodes on the output side of the cell converters reliably limit first the reverse voltage thereof, second the turn-on current thereof and third the rates of rise of the turn-on and turn-off voltages thereof. Separate monitoring of diodes connected in this manner is unnecessary, as they operate in “natural ZVS”. Each multiresonant cell converter produces, even without regulation, a defined and stable no-load output voltage. Fourth, these resonant capacitors in parallel with the converter output diodes increase the operating area in which the active switch can operate in correct ZVS, compared to otherwise identical cell converters without such capacitors.

Quasi-parallel operation of a plurality of light emitting diodes and/or a plurality of light emitting diode strings using a common electrical energy converter having one unidirectionally blocking or short-circuiting rectifier per light emitting diode string is proposed, wherein the currents flowing through the light emitting diodes are approximately identical. Control action needs to be applied only to the current in one light emitting diode or string of light emitting diodes. For this purpose a converter is used which outputs a pulsating DC voltage or an AC voltage.

As a result, a plurality of LEDs operated on one converter can be connected to one reference potential, thereby allowing better cooling, since, for example, all the light emitting diodes can be soldered directly onto copper, and a plurality of light emitting diode strings can be operated using one converter. When light emitting diode strings are used, the number of light emitting diodes can be selected such that the insulation resistance used can be optimally utilized. According to the invention, strings with different numbers of light emitting diodes can also be connected in parallel, a single DC/DC converter being required for operating all the light emitting diodes. A further advantage is the much lower circuit complexity compared to the prior art wherein hitherto a separate converter has been necessary for each light emitting diode or each light emitting diode string.

The concept is transferable to any DC/DC converter topologies (step-up and/or step-down converter topologies). Dimming of individual light emitting diodes is possible using a transistor connected in parallel with the light emitting diode and controlled by a pulse width modulated signal. All the outputs of the converter are short-circuit-proof due to the current control and current balancing. The circuit is tolerant to differences in the forward voltages of the light emitting diodes. The circuit principle is applicable to any input voltages, and can be used e.g. from 6 Vdc (flashlight), 12 Vdc (motor vehicle), 24 Vdc (truck) through to 277 Vdc. The circuit must be adapted accordingly, and the transformer possibly incorporated is also used for voltage adjustment and possibly also for isolation in order to comply with the relevant safety requirements.

Further advantageous developments and embodiments of the inventive circuit arrangement for operating at least two semiconductor light sources will emerge from additional dependent claims and from the following description.

### BRIEF DESCRIPTION OF THE DRAWING(S)

Further advantages, features and details of the invention will emerge from the following description of exemplary embodiments and with reference to the drawings in which identical or functionally identical elements are provided with the same reference characters, and wherein:

FIG. 1 shows the principle of using a common mode choke Lcm for balancing the two LED currents Io1 and Io2,

FIG. 2 shows the balancing of the two output currents Io1 and Io2 by the common mode choke Lcm over a wide range independently of the LED forward voltages Vo1 and Vo2,

FIG. 3 shows the balancing of the two output currents Io1 and Io2 despite markedly different loads,

FIG. 4 shows the automatic bypassing of D2 in the event of an open circuit fault,

FIG. 5 shows the balancing of the two output currents Io1 and Io2 by the common mode choke Lcm over a wide range independently of the loads constituted by R1 and R2,

FIG. 6 shows the omission of rectification and a discontinuous flow of current through the light emitting diodes in the case of unbalanced loading of the current source,

FIG. 7 shows the omission of rectification and a discontinuous flow of current through the light emitting diodes in the case of balanced loading of the current source,

FIG. 8a shows the balancing of a plurality of light emitting diodes or light emitting diode strings by means of a plurality of interconnected common mode chokes according to a circuit variant A (tree structure),

FIG. 8b shows the balancing of a plurality of light emitting diodes or light emitting diode strings by means of a plurality of interconnected common mode chokes according to a circuit variant B (ring structure),

FIG. 8c shows an embodiment of circuit variant B without Lcm5,

FIG. 8d shows an embodiment of circuit variant B without Lcm5 with unbalanced doubler circuit as rectifier and ZVS half-bridge circuit for implementing the alternating current source,

FIG. 8e shows an embodiment of circuit variant B without Lcm5 with unbalanced doubler circuit as rectifier and class E converter for implementing the alternating current source and which additionally uses the leakage inductances of the common mode chokes as resonant inductances,

FIG. 8f shows the balancing of a plurality of light emitting diodes or light emitting diode strings by means of a plurality of interconnected common mode chokes according to a circuit variant C (series parallel structure),

FIG. 8g shows the balancing of a plurality of light emitting diodes or light emitting diode strings by means of a plurality of interconnected common mode chokes according to a circuit variant C with particularly advantageous current measuring circuit,

FIG. 9 shows an uneven distribution of the light emitting diode currents in the ratio 3:5 by appropriate interconnection of three common mode chokes Lcm1 . . . Lcm3 each having a 1:1 turns ratio,

FIG. 10a shows a buck converter with current balancing and two outputs each having a flux diode that is not part of the actual converter topology, and with inductive coupling-out of the LED current measured value,

FIG. 10b shows the buck converter with current balancing and two outputs as in FIG. 10a, with resistive determination of the LED current measured value and comparator Cmp1 for detecting a pulsating current in the converter inductor L1,

FIG. 10c shows a buck converter with current balancing and three outputs,

FIG. 11 shows the current balance at the buck converter having current balancing and two outputs,

FIG. 12 shows a more precise plot of the current balance,

FIG. 13 shows a particularly advantageous embodiment of the buck converter having current balancing and two outputs and using the leakage inductance of the common mode choke as converter inductance,

FIG. 14 shows further measurements of the buck converter having current balancing and two outputs in comparison,

FIG. 15 shows the increasing of the output currents in the particularly advantageous embodiment of the buck converter having current balancing and two outputs by increasing the input voltage,

FIG. 16a shows a buck-boost converter having two outputs based on a Ćuk converter in a variant A1,

FIG. 16b shows a buck-boost converter having two outputs based on a Ćuk converter in a variant A2, wherein the two leakage inductances of the common mode choke constitute the converter output inductances,

FIG. 17a shows a buck-boost converter with two outputs based on a Ćuk converter in a variant B1 and having only one converter output inductance, but having for each output a flux diode not forming part of the actual converter topology,

FIG. 17b shows a buck-boost converter having two outputs based on a Ćuk converter in a variant B2, wherein the converter output inductance is constituted by the leakage inductances of the common mode choke, and wherein each output has a flux diode not forming part of the actual converter topology,

FIG. 18a shows a buck-boost converter having two outputs based on a SEPIC converter in a first variant,

FIG. 18b shows a buck-boost converter having two outputs based on a SEPIC converter in a second variant, wherein the converter output inductances are constituted by the leakage inductances of the common mode choke,

FIG. 19 shows a half-bridge inverter with resonant output circuit consisting of Lr, Cr1 and Cr2 [which] implements an alternating current source in the arrangement similar to the circuit variant B without Lcm5 from FIG. 8c,

FIG. 20a shows a half-bridge inverter with reverse short-circuiting rectifiers or more specifically unbalanced voltage doublers (identical to FIG. 8d!),

FIG. 20b shows another diagram of the half-bridge inverter with reverse short-circuiting rectifiers, wherein each common mode choke is replaced by an equivalent circuit comprising a transformer and two leakage inductances Ls, and wherein the leakage inductances operate in series with the resonant inductor Lr,

FIG. 20c shows an advantageous further development of the half-bridge inverter with reverse short-circuiting rectifiers, wherein the totality of the leakage inductances Ls completely assume the function of the resonant choke Lr, and wherein for each rectifier input a resonant capacitor is indicated for turning the circuit into a multiresonant half-bridge converter,

FIG. 21a shows a half-bridge inverter having three reverse blocking and three forward blocking rectifiers,

FIG. 21b shows another diagram of the half-bridge inverter from FIG. 21a, wherein each common mode choke is replaced by an equivalent circuit consisting of a transformer and two leakage inductances Ls, and wherein the leakage inductances operate in series with the resonant inductance Lr,

FIG. 21c shows an advantageous embodiment of the half-bridge inverter from FIG. 21b, wherein the totality of the leakage inductances Ls completely assume the function of the resonant choke Lr, and wherein for each rectifier input a resonant capacitor is indicated for turning the circuit into a multiresonant half-bridge converter,

FIG. 21d shows an advantageous embodiment of the half-bridge inverter from FIG. 21c, wherein the totality of the leakage inductances Ls completely assume the function of the resonant choke Lr, having an additional transformer Tr which is used for galvanic isolation and/or for voltage adjustment,

FIG. 21e shows an advantageous further development of the half-bridge inverter from FIG. 21d with primary-side current measurement,

FIG. 21f shows an advantageous further development of the half-bridge inverter with purely reverse blocking rectifiers and the additional transformer Tr which is used for galvanic isolation and/or for voltage adjustment, wherein the transformer has two secondary windings ns1 and ns2 of opposite polarity,

FIG. 22 shows a pulse width modulation controller using fixed-frequency pulse width modulation,

FIG. 23 shows a pulse width modulation controller operated in boundary current mode, wherein neither switching frequency nor on- or off-time are constant,

FIG. 24 shows a controller based on a current mode control principle,

FIG. 25 shows another embodiment of a buck converter with three outputs and having current direction and current zero crossing detection,

FIG. 26 shows a step-up converter having two outputs, wherein the common mode choke must be provided at a location in the converter that is not intended for an inductor, for which reason an additional voltage limiting branch connected to the converter input inductor is required,

FIG. 27 shows a buck-boost converter having corresponding monitoring of the demagnetization of the common mode chokes,

FIG. 28a shows the block diagram of a circuit arrangement for balancing of the two load currents I1 and I2 by the DC voltage V0 appearing across the capacitor C0 in the case of two series-connected reverse short-circuiting rectifiers with voltage doubling (circuit type VVD),

FIG. 28b shows the block diagram of a circuit arrangement for balancing of the two load currents I1 and I2 by the DC voltage V0 appearing across the capacitor C0 in the case of two series-connected reverse short-circuiting rectifiers with current output (circuit type CD),

FIG. 28c shows the situation for type VVD for the case Ii>0,

FIG. 28d shows the situation for type VVD for the case Ii=0,

FIG. 28e shows the situation for type VVD for the Ii<0,

FIG. 28f shows selected current and voltage waveforms of the circuit according to FIG. 28a,

FIG. 28g shows the block diagram of a circuit arrangement for balancing of the two load currents I1 and I2 by the DC voltage V0 appearing across the capacitor C0 in the supply voltage path in the case of a reverse and a forward blocking rectifier connected in parallel and having a single voltage output (circuit type VD),

FIG. 28h shows the situation for type VD according to FIG. 28k for the case Ii>0,

FIG. 28i shows the situation for type VD according to FIG. 28k for the case Ii=0,

FIG. 28 shows the situation for type VD according to FIG. 28k for the case Ii<0,

FIG. 28k shows the block diagram of a circuit arrangement for balancing the two load currents I1 and I2 by the DC voltage V0 appearing across the capacitor C0 which is connected between the voltage source and the reference potential in the case of a reverse and a forward blocking rectifier having a single voltage output (circuit type VD) in a parallel connection,

FIG. 29a shows a circuit arrangement for balancing the LED currents I11, I12, . . . , I32 in spite of different loads (circuit type VVDa),

FIG. 29b shows a circuit arrangement for balancing the LED currents I11, I12, . . . , I32 in spite of different loads (circuit type CDa),

FIG. 29c shows a circuit arrangement for balancing the LED currents I11, I12, . . . , I32 in spite of different loads (circuit type VDa),

FIG. 29d shows a circuit arrangement for balancing the LED currents I11, I12, . . . , I32 in spite of different loads using different rectifier pairs (circuit type CDVVDVDa),

FIG. 30a shows a circuit arrangement for balancing the LED currents I11, I12, . . . , I32 in spite of different loads (circuit type VVDb),

FIG. 30b shows a circuit arrangement for balancing the LED currents I11, I12, . . . , I32 in spite of different loads (circuit type CDb),

FIG. 30c shows a circuit arrangement for balancing the LED currents I11, I12, . . . , I32 in spite of different loads (circuit type VDb),

FIG. 30d shows a circuit arrangement for balancing the LED currents I11, I12, . . . , I32 in spite of different loads using different rectifier pairs (circuit type CDVVDVDb),

FIG. 31 shows a circuit arrangement for balancing the LED currents I1, I2, I3, and I4 in spite of different and switched loads (circuit type VVDb),

FIG. 32 shows a class E converter as a source for supplying the circuit according to FIG. 31,

FIG. 33 shows a basic converter arrangement with common mode choke Lcm as current sharing network,

FIG. 34 shows the possibilities A) to C) as “building blocks” of converters, wherein direct current through the common mode choke Lcm is prevented using two capacitors,

FIG. 35 shows the possibilities A) to C) from FIG. 34 combined in a single diagram to produce the resonant cell, wherein optional resonant capacitors Cr (here connected to ground, for example) are shown,

FIG. 36 shows the generalization of the building block according to FIG. 35,

FIG. 37 shows the circuit according to FIG. 2, with resonant cell CCC1 indicated,

FIG. 38 shows a ZVS half-bridge converter which uses the leakage inductances of the common mode chokes,

FIG. 39a shows the basic structure of the step-down or buck converter with positions for ZVS-enabling resonant elements indicated,

FIG. 39b shows the basic structure of the step-up or boost converter with positions for ZVS-enabling resonant elements indicated,

FIG. 39c shows the basic structure of the Ćuk converter with positions for ZVS-enabling resonant elements indicated,

FIG. 40 shows a multiresonant Ćuk converter which uses the common mode choke Lcm1 for balancing the two LED currents Io1 and Io2, and which utilizes the leakage inductance of Lcm1 as resonant inductance,

FIG. 41 shows voltage and current waveforms of the multiresonant Ćuk converter,

FIG. 42 shows a multiresonant inherently current balancing SEPIC converter,

FIG. 43 shows a multiresonant inherently current balancing Zeta converter,

FIG. 44 shows an inherently current balancing class E converter having hard-switching rectifier diodes,

FIG. 45 shows a multiresonant inherently current balancing class E converter,

FIG. 46 shows a multiresonant inherently current balancing buck converter,

FIG. 47 shows a multiresonant inherently current balancing boost converter,

FIG. 48 shows a multiresonant inherently current balancing buck-boost converter,

FIG. 49 shows a multiresonant Ćuk converter having 4 inherently current balancing outputs by 3 common mode chokes in a tree connection,

FIG. 50 shows a multiresonant Ćuk converter having 3 inherently current balancing outputs by 3 common mode chokes in a symmetrical ring connection,

FIG. 51 shows a multiresonant Ćuk converter having 2 outputs, the currents of which are inherently mutually adjustable by 3 common mode chokes in the ratio 3:5,

FIG. 52 shows a multiresonant inherently current balancing flyback converter,

FIG. 53a shows an isolated multiresonant inherently current balancing Ćuk converter with common positive terminal of the outputs,

FIG. 53b shows a completely isolated multiresonant inherently current balancing Ćuk converter,

FIG. 54a shows an isolated multiresonant inherently current balancing Zeta converter with common negative terminal of the outputs,

FIG. 54b shows a completely isolated multiresonant inherently current balancing Zeta converter,

FIG. 55a shows a completely isolated multiresonant inherently current balancing SEPIC converter with split blocking capacitor,

FIG. 55a shows a completely isolated multiresonant inherently current balancing SEPIC converter with common blocking capacitor.

### PREFERRED EMBODIMENTS OF THE INVENTION

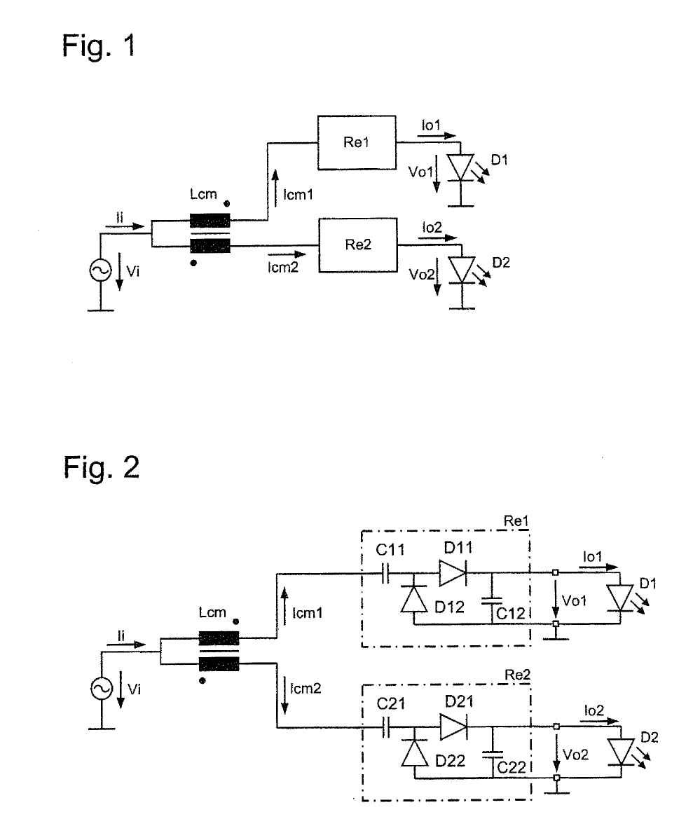

FIG. 1 shows the inventive principle of LED current balancing by means of a common mode choke of the kind used in line filters to attenuate common mode interference. However, in contrast to such applications as filters, here 2 terminals of the common mode choke are always interconnected. The alternating current source supplies the current Ii which is divided by the common mode choke Lcm into two identical currents Icm1 and Icm2. These are rectified by the rectifiers Re1 and Re2. The resulting direct currents Io1 and Io2 likewise possess the same strength and feed the light emitting diodes D1 and D2. The direct currents Io1 and Io2 are to a very good approximation independent of the forward voltages Vo1 and Vo2 of the diodes used. The voltage at the alternating current source Vi is a function of the impressed current Ii and the rectifier arrangement used including loads, i.e. light emitting diodes.

FIG. 2 shows a specific implementation of the rectifier as an unbalanced voltage doubler circuit. Instead of the unbalanced voltage doubler circuit, other rectifier circuits such as a half-wave rectifier, a balanced voltage doubler or a multistage voltage multiplier circuit, also known as a cascade circuit or Cockroft-Walton circuit, could also be used.

It is important generally that the two currents Icm1 and Icm2 should or must pass through zero during each cycle so that the core of the common mode choke is demagnetized again. Otherwise, after a few cycles the common mode choke loses its balancing effect, as the core goes into saturation because of a DC voltage component and two uncoupled inductors, each having an inductance corresponding to the leakage inductance, are then left over.

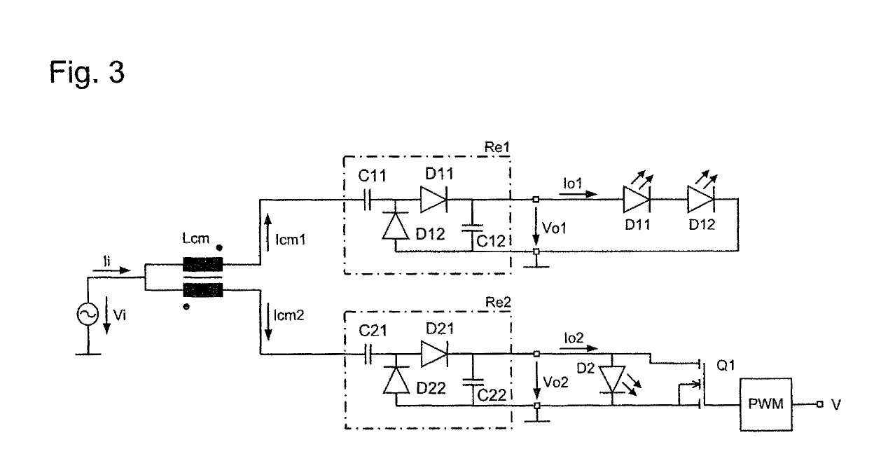

FIG. 3a shows another version of the circuit shown in FIG. 2, wherein markedly different loads are present at the two outputs. In contrast to FIG. 2, a light emitting diode string comprising two light emitting diodes is used at one output, whereas a single light emitting diode can be intermittently short-circuited at the second output by means of the transistor Q1. Dimming of the light emitting diode D2 can be implemented via the pulse width modulator PWM using the control signal V.

The current source is here implemented using a sine wave generator with a frequency of 48 kHz and a series resistance of 50 ohms. Depending on the amplitude of the signal generator, the cases 1 to 3 arise, as listed in the table below. In the cases 1 and 2 the transistor Q1 is turned off (0% duty cycle), whereas in case 3 the transistor is turned on (100% duty cycle). The very good balancing of the two output currents Io1 and Io2 despite markedly different loading of the two outputs may be observed.

TABLE 1
Measured values for the circuit according to FIG. 3

| Case | Io1 [mA] | Io2 [mA] | Vo1 [V] | Vo2 [V] |
|---|---|---|---|---|
| 1 | 1.06 | 1.06 | 3.051 | 1.526 |
| 2 | 15.33 | 15.33 | 3.410 | 1.768 |
| 3 | 17.06 | 17.13 | 3.429 | 0 |

Light emitting diode failure in such a circuit arrangement will now be considered. In the event of a short circuit failure, all the other light emitting diodes in the circuit are operated with rated current, which is to be considered as “optimum behavior in the event of a fault”. On the other hand, if a light emitting diode suffers open circuit failure, the voltage across this light emitting diode increases to a multiple of the forward voltage and, in addition, all the other light emitting diodes are operated with excessively low currents. Only partial balancing is possible. However, the high voltage across the defective light emitting diode may, on the other hand, be deemed an advantage, as this greatly simplifies detection of the defective light emitting diode and allows automatic bypassing of this light emitting diode by means of the switch or more specifically transistor provided anyway for dimming. In safety-relevant applications such as in the automotive sector, emergency operation can be therefore ensured in both fault scenarios—open and short circuit.

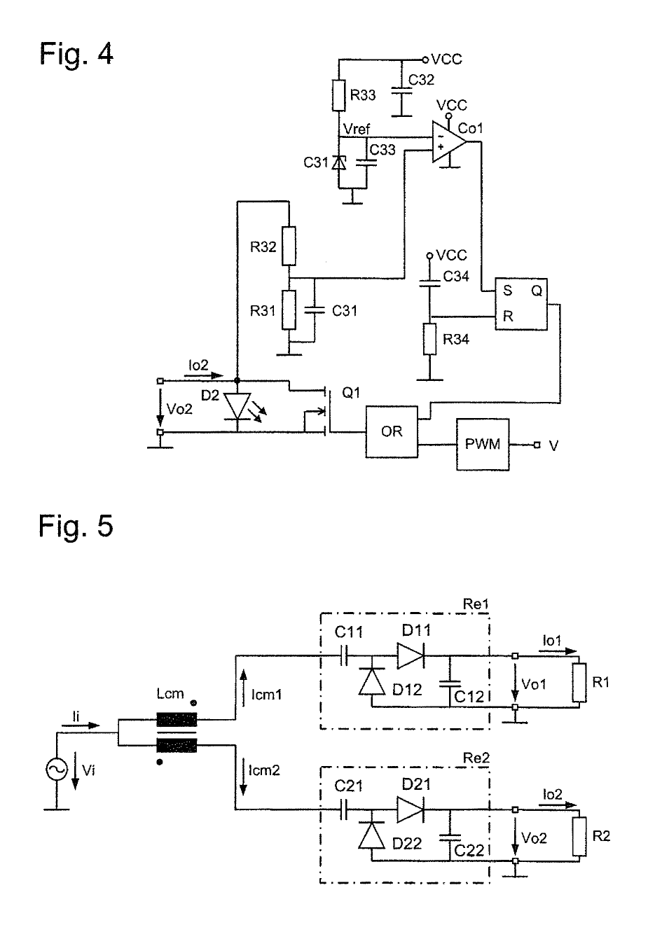

FIG. 4 shows the section around the diode D2 from an expanded circuit according to FIG. 3. If the light emitting diode D2 fails due to an open circuit, because of the high voltage across D2 which is generated by the common mode choke, the comparator will change state, set the flipflop that was reset at turn-on, and therefore permanently turn-on Q1.

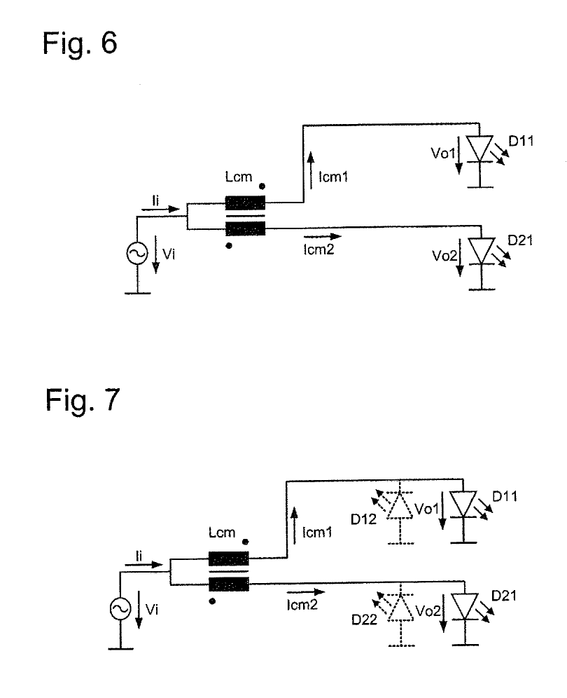

In principle this kind of current balancing works not only for light emitting diodes, but also for any loads such as those shown, for example, in FIG. 5. Here any conceivable loads are represented by R1 and R2. As balanced loads are assumed, the rectifier circuits Re1 and Re2 including the associated smoothing capacitors can be omitted. FIG. 6 shows such a circuit with light emitting diodes as the load. The result is a discontinuous flow of current through the light emitting diodes—only in the positive half-wave of the current source does current flow through the two light emitting diodes. In the negative half-wave, the two light emitting diodes are turned off. The reverse voltage corresponds to the no-load voltage of the non-ideal current source.

In the case of an ideal current source having an infinitely high no-load voltage, the circuit according to FIG. 7 must be used in order to prevent the light emitting diodes from being destroyed because of an excessively high reverse voltage. Instead of one light emitting diode, two antiparallel connected light emitting diodes are used at the two outputs of Lcm. The current source is now loaded for both polarities.

Current balancing by the common mode choke is operative both in the case of FIG. 6 and FIG. 7, as it is ensured that the two inductor currents return through zero during a cycle, i.e. demagnetization of the core of the common mode choke is made possible, thereby meeting the above requirement. However, it is not advisable to omit the rectifier circuit, because due to the high ripple content of the light emitting diode current this would result in a reduction in the light yield of the light emitting diodes.

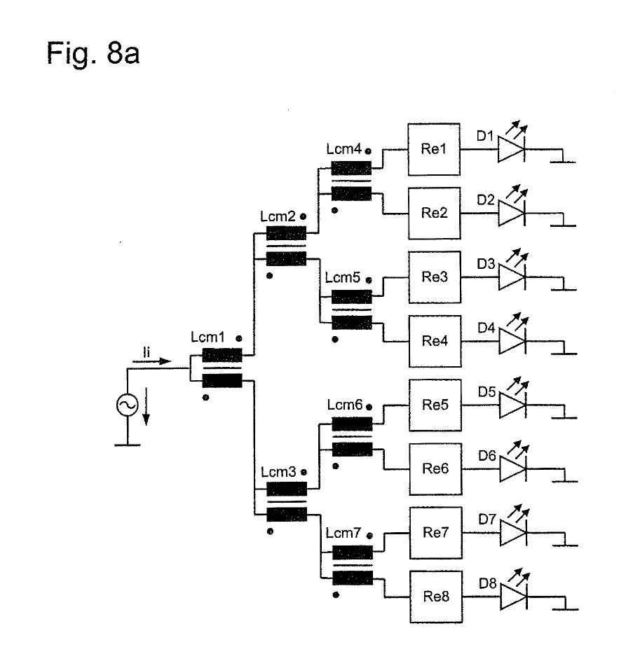

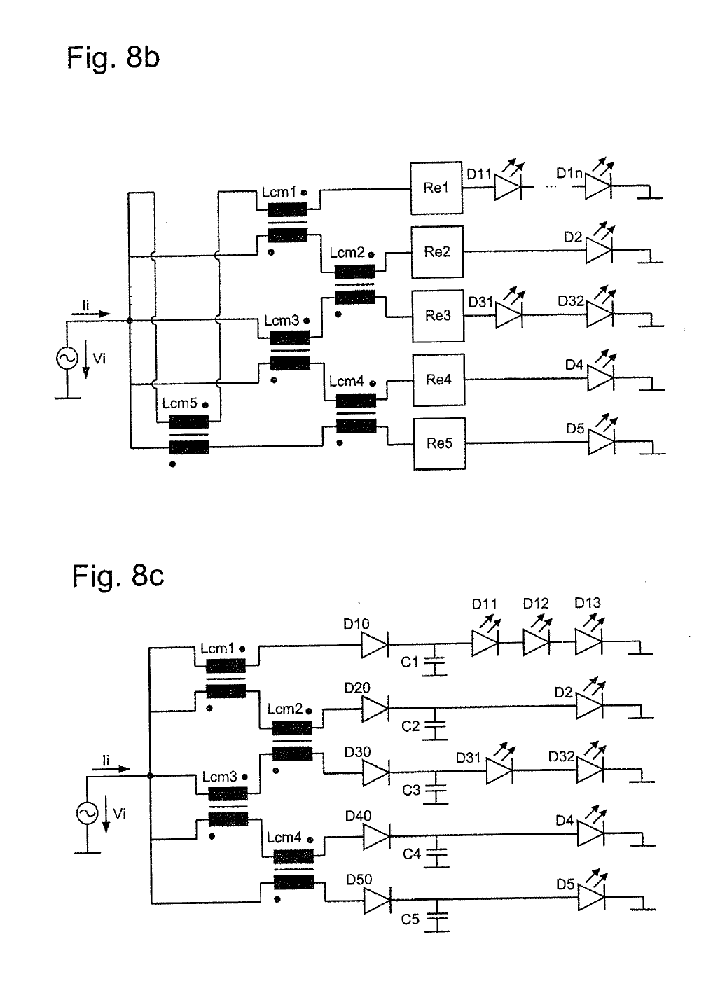

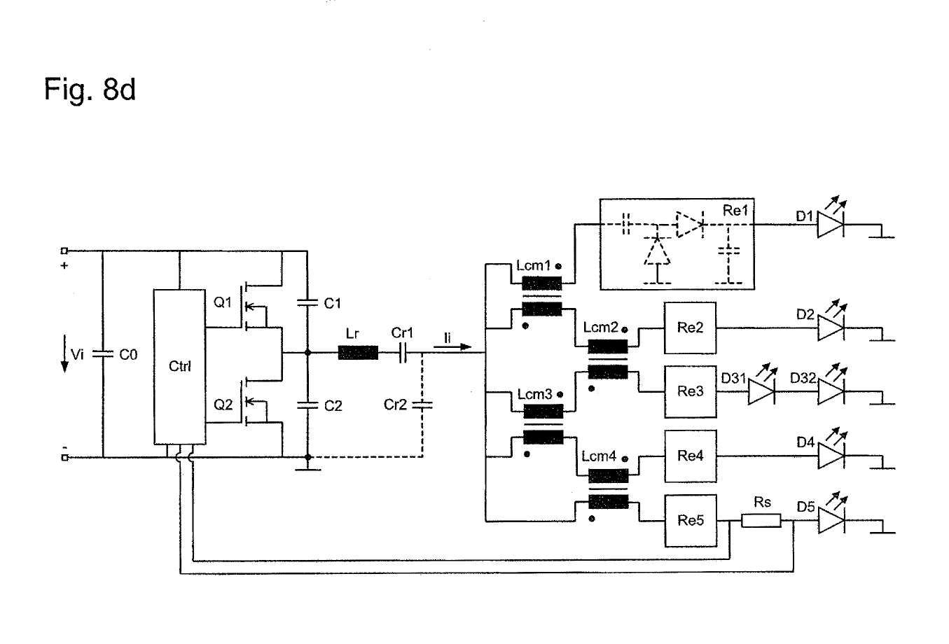

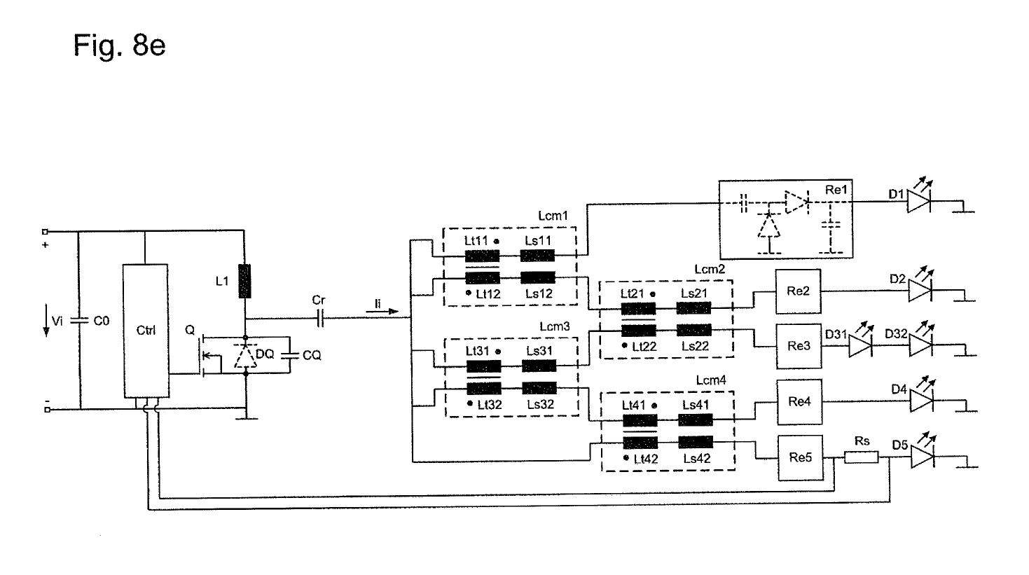

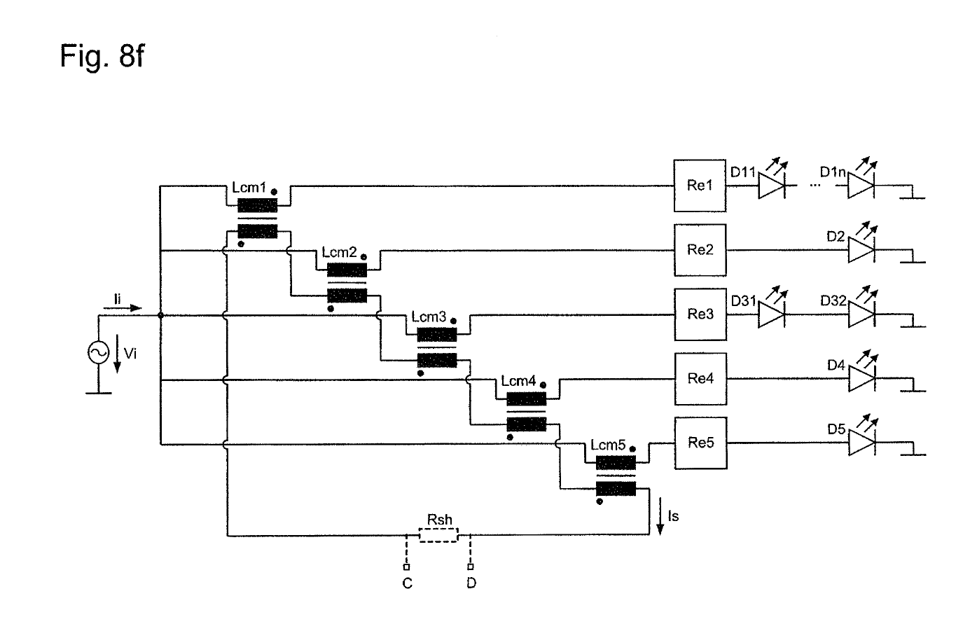

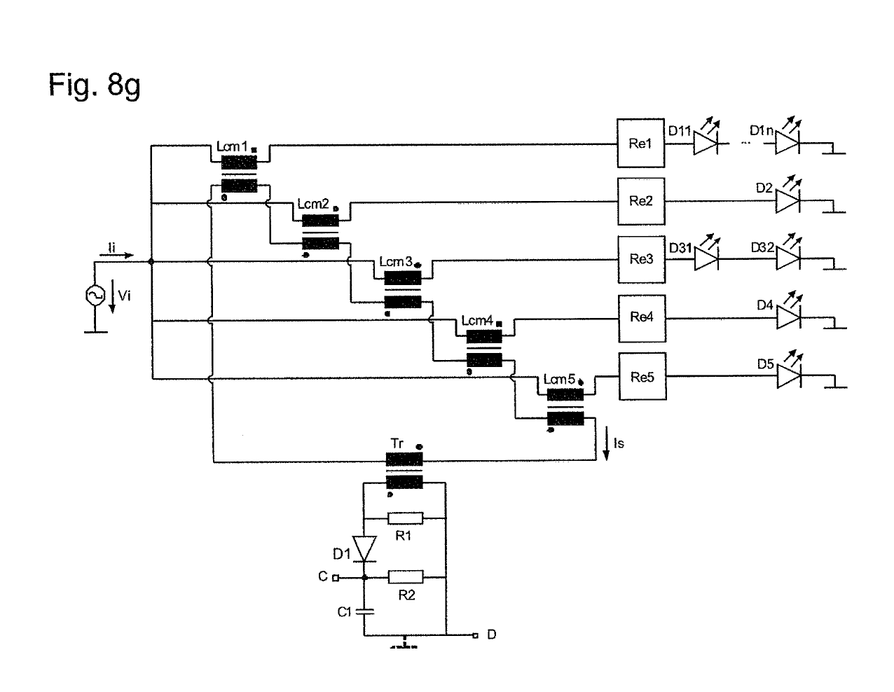

If in contrast to the diagram in FIG. 1 more than two light emitting diodes or light emitting diode strings are operated, this is possible using a plurality of common mode chokes. FIG. 8a shows a first circuit variant A, FIG. 8b shows a second circuit variant B illustrating how common mode chokes can be interconnected to supply a plurality of light emitting diodes or light emitting diode strings with the same currents.

Variant B has the advantage over variant A that, on the one hand, provided the same current is required through all the light emitting diodes, the number of outputs does not need to be a power of 2 (at least if only 1:1 inductors are to be used and the same current is required through all the light emitting diodes) and, on the other hand, that all the common mode chokes must be designed for the same load current.

The common mode choke Lcm5 is optional and results in a “ring closure” which improves the balanced distribution of the currents to the outputs. However, this must be regarded as somewhat theoretical, as this effect has no significant impact in practice, not least because of the already very good balancing. For cost and efficiency reasons, the inductor Lcm5 will not therefore be used in the usual applications, as an additional ohmic resistance causes losses. The variant A requires n chokes for n outputs, variant B “without ring closure” requires n−1 chokes for n outputs.

FIG. 8c shows a specific embodiment of FIG. 8b, wherein the common mode choke Lcm5 has been omitted and only single half-wave rectifiers are used as rectifiers.

FIG. 8d shows another specific example of circuit variant B similar to FIG. 8b, but without Lcm5, wherein an unbalanced doubler circuit is used as rectifier and a ZVS half-bridge circuit is used to implement the alternating current source.

Another embodiment of circuit variant B according to FIG. 8b, but without Lcm5, is shown in FIG. 8e, an unbalanced doubler circuit being used as rectifier and a class E converter for implementing the alternating current source. In addition, the leakage inductances of the common mode chokes are used as resonant inductances.

FIG. 8f shows a variant C that is already known from the prior art, DE 10 2006 040 026 and WO 2005/038828 A2, for cold-cathode lamps. Variant C has the same advantages as variant B, but n inductors are required. In the field of cold-cathode lamps, it is prior art practice to check the operation of the circuit arrangement using a shunt resistor Rsh disposed in the secondary circuits. This can take place in a similar manner in LED circuits, which is facilitated by the galvanic isolation. However, in common mode chokes having a 1:1 transformation ratio, correspondingly high secondary currents Is flow, so that for dissipation reasons only small resistance values for Rsh are used, with the attendant difficulty of small measurement voltages. The arrangement according to FIG. 8g eliminates this disadvantage, and also the disadvantage that a high-frequency AC voltage has been provided for the controller, by using a current transformer Tr with associated circuitry for current measurement.

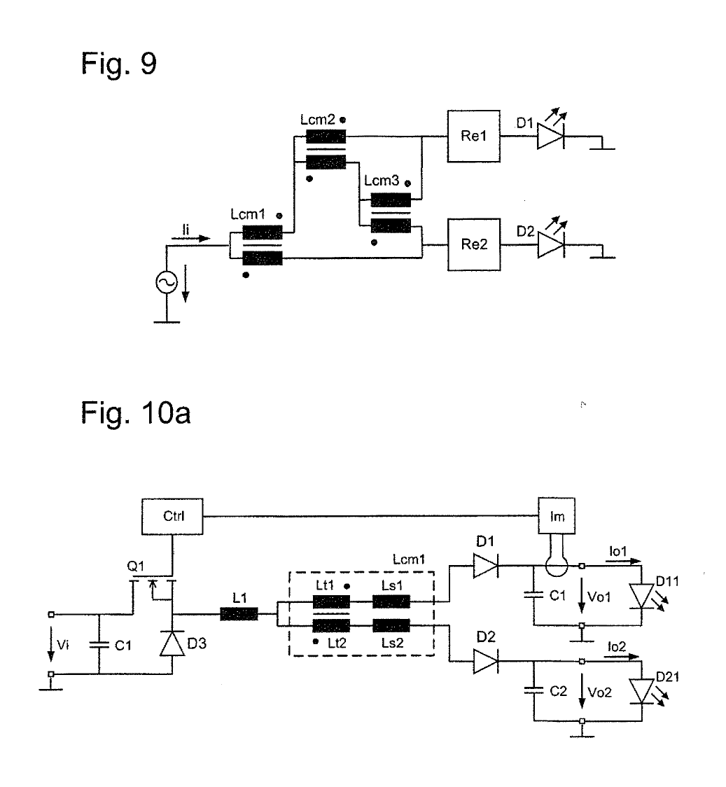

Although the arrangements according to FIGS. 8a, 8b and 8f also allow different large currents through the light emitting diodes or light emitting diode strings, it is only ever possible for the light emitting diode currents to be distributed in fixed ratios. For example, the current through the light emitting diode D1 and that through the light emitting diode D2 in FIG. 9 are in the ratio 3 to 5. Such an arrangement can be advantageous in particular for operating a plurality of light emitting diodes of different types e.g. in a luminaire, e.g. using a combination to produce a high-yield warm white by combining cold white light emitting diodes and red light emitting diodes having a high yield in each case.

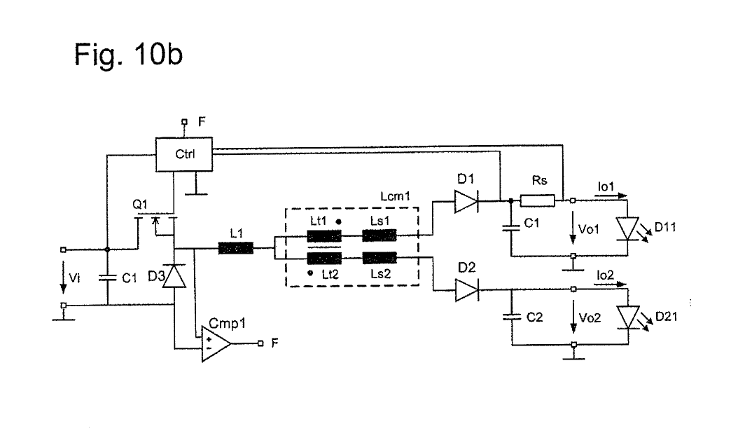

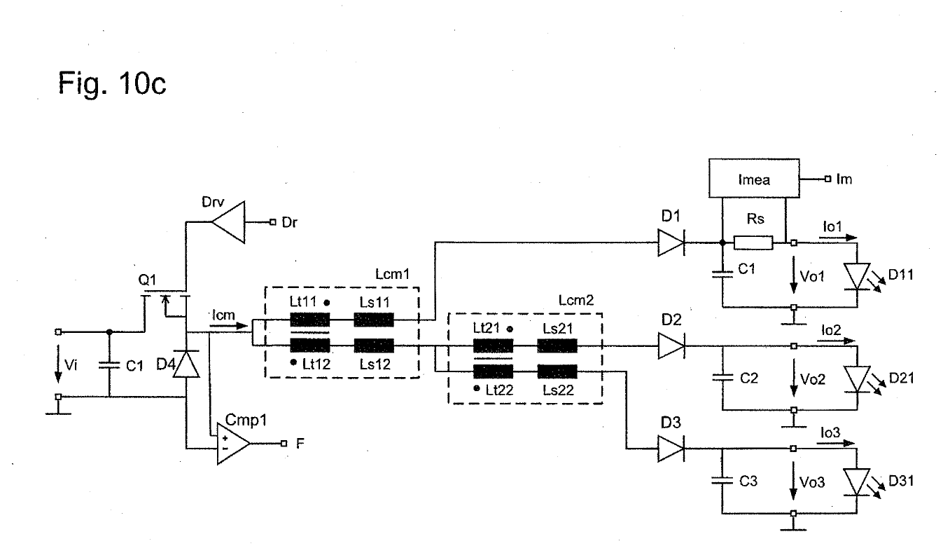

The circuit according to FIG. 10a is based on a buck converter, comprising an input capacitor C1, a switching transistor Q1, a step-down inductor L1 and a diode D3 in order to produce a pulsating direct current through the inductor L1. This current is distributed using the common mode choke Lcm1 to the two rectifiers comprising D1, C1 and D2, C2 and is finally provided at the two outputs of the light emitting diodes D11 and D12. One of the two light emitting diode currents is detected using the current measuring device Im and fed to the controller Crtl which varies the duty cycle of the transistor Q1. Instead of two outputs, a plurality of outputs could also be generated, similarly to the above circuits. Likewise, instead of single light emitting diodes, light emitting diode strings could also be used.

FIG. 10b shows a further development of the circuit in FIG. 10a, wherein current measurement is performed using the shunt Rs. More important, however, is the comparator Cmp1 at whose output F (“freewheel signal”) a Low signal is generated as long as the diode D1 is conducting. Conduction of D1 is synonymous with freewheeling of the inductor L1, i.e. the current in L1 reduces, as energy stored in L1 is transferred to the capacitors C1 and/or C2. If L1 is current-free, because of the two diodes D1 and D2, the common mode choke Lcm1 must also be current-free. Therefore, the demagnetization of the common mode choke Lcm1 can be detected by waiting at least until F becomes High again after the opening of the switch Q1 and the subsequent switching to Low of the comparator output F.

FIG. 10c shows a buck converter having three outputs, wherein only the leakage inductances of the common mode chokes are used as storage chokes of the converter. The current measuring device Imea determines one of the output currents and supplies a measurement signal proportional to that output current and referred to GND. The comparator Cmp1 is used to detect the demagnetization of the common mode chokes Lcm1 and Lcm2. The measurement signals Im and F are fed to the controller (not shown) which in turn generates therefrom the control signal Dr for the power switch.

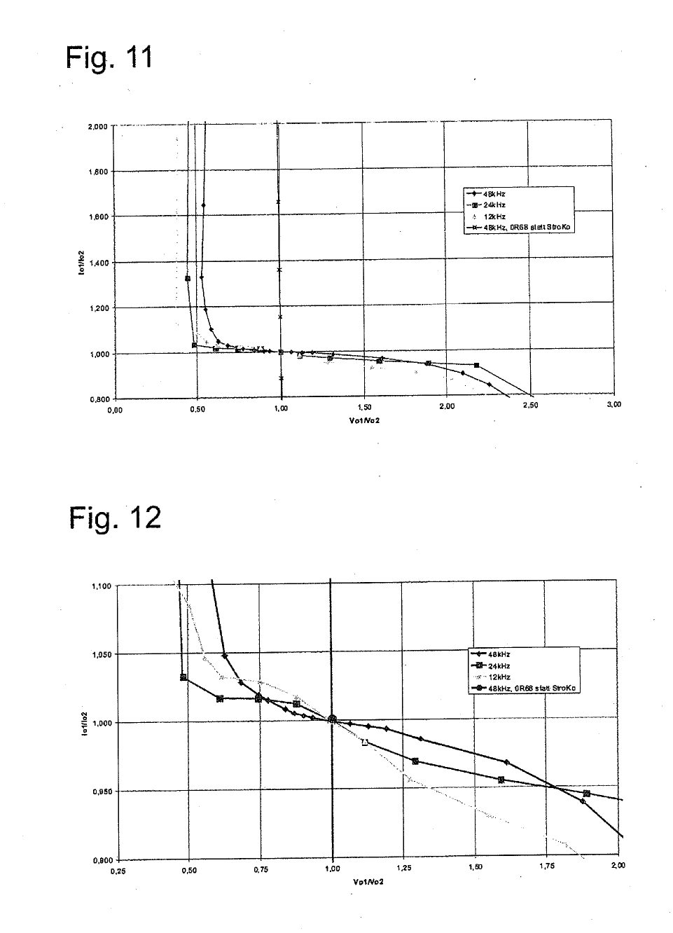

FIGS. 11 and 12 show current balance measurements for a circuit according to FIG. 10a. The ratio Io1/Io2=1 should ideally be independent of the ratio of the two output voltages Vo1/Vo2.

For the measurement, the controller has been overridden and the transistor controlled using a constant duty cycle of 50% and constant frequency in order to enable effects produced by the controller and variations in the duty cycle to be eliminated, and therefore enable the effect of balancing to be tested in a particularly simple manner. The switching frequency was varied between 12, 24 and 48 kHz in three series of measurements. The input voltage was maintained constant at 10V and the load at the 2nd output was varied, while that at the 1st output remained unchanged (at 150 ohms). In this embodiment, the inductor L1 has a value of 100 uH. The common mode choke used is of type EPCOS B82721K2701-N20 having an inductance of 2×10 mH, a series resistance of 2×0.60 ohms and a rated current of 0.7 A.

It can be seen from FIG. 12 that at lower switching frequency the current balance is still ensured even for lower Vo1/Vo2 ratios and therefore for larger loads. The reason for this is that at lower switching frequency the converter only goes into continuous mode in the case of a higher load.

The curve 81 demonstrates the operation of the arrangement—here the common mode choke has been replaced by two 0.68 ohm resistors in order to illustrate the balancing effect achieved by the series resistance of the common mode choke alone.

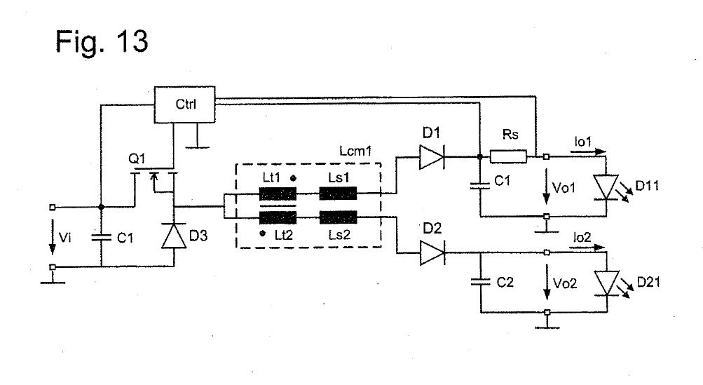

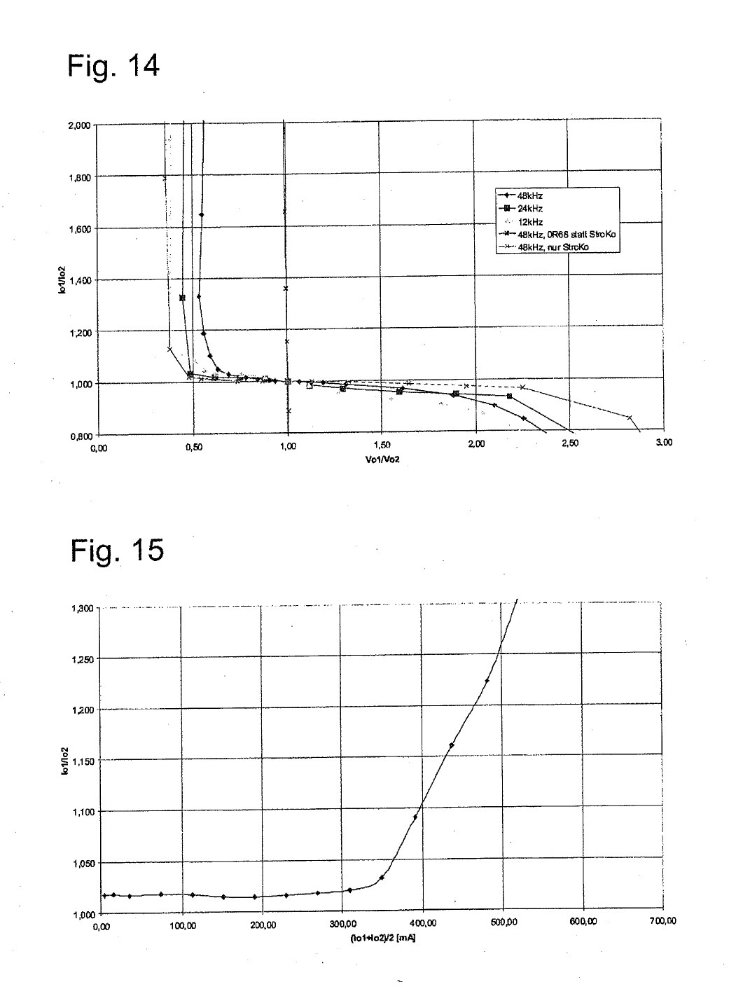

FIG. 13 shows a particularly advantageous embodiment of the converter according to FIG. 10a. Here current measurement is performed by evaluating the voltage dropped across the shunt Rs. More important, however, is the “saving” of the “actual step-down converter inductor” L1—instead of which the two leakage inductances Ls1 and Ls2 of the common mode choke are used for this purpose. This also results in improved balancing of the two output currents, as can be seen from FIG. 14.

As with all the measurements mentioned here, the converter according to FIG. 13 was operated with current control deactivated in order to show the extent to which the balancing of the output currents decreases as the output currents increase. For this purpose the converter was loaded with R1=75 ohms and R2=150 ohms and the input voltage was increased incrementally. FIG. 15 shows the ratio of the two output currents Io1/Io2 versus the average output current (Io1+Io2)/2. It can be seen that up to an average current of 350 mA, the “unbalance” remains below 5%. This corresponds to half the rated current of 700 mA of the common mode choke used.

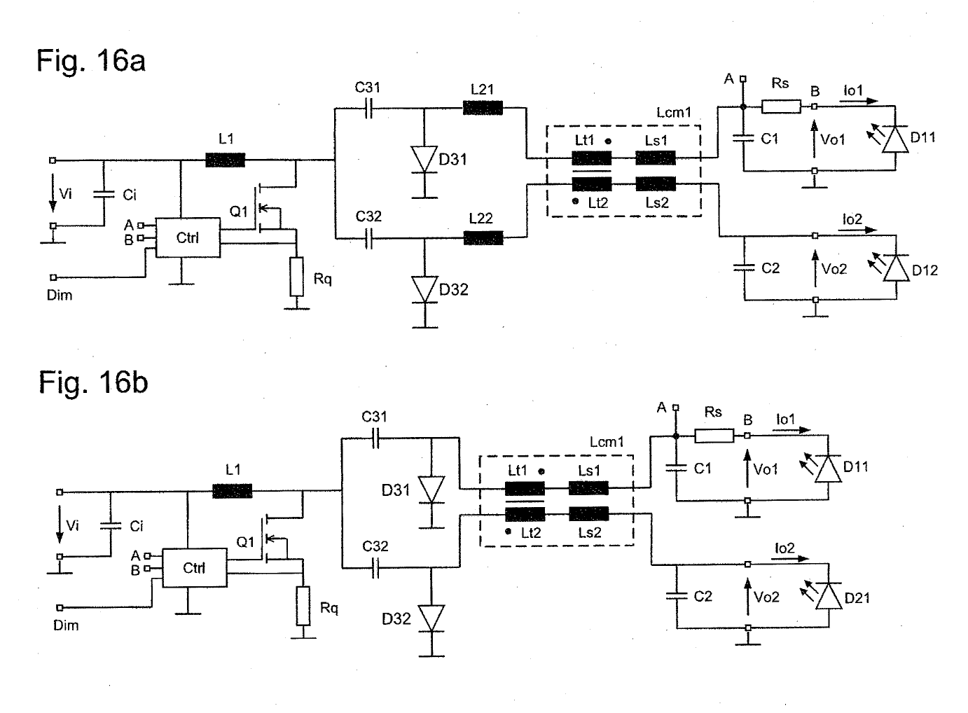

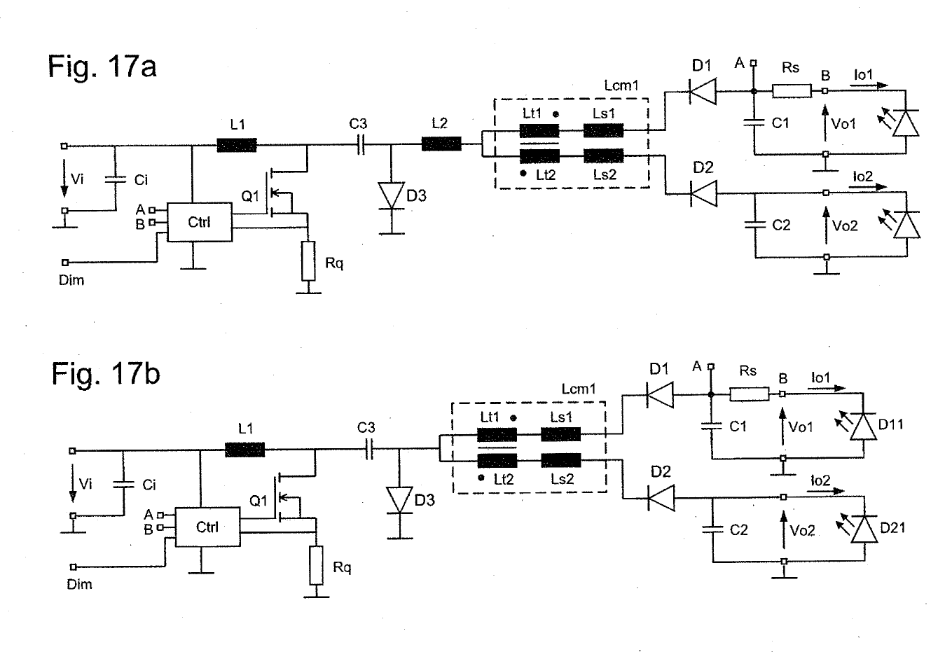

FIGS. 16 and 17 illustrate two inventive embodiments based on the Ćuk converter concept. The circuits shown in FIGS. 16a and 16b use the capacitors C31 and C32 to prevent any flow of direct current through the common mode choke that would occur because of the different output voltages. The circuits in FIGS. 17a and 17b use diodes D1 and D2 for this purpose, similarly to the implementation in the converters already described.

As in the case of the buck converter explained above, the output-side inductor L2 in FIG. 17a or the inductors L21 and L22 in FIG. 16a can be omitted, as shown in FIGS. 16b and 17b, wherein the leakage inductances Ls1 and Ls2 of the common mode choke jointly assume the function thereof.

In the case of a converter with n outputs, in the implementation according to FIG. 16 n capacitors and n diodes are required in the output circuits (C31, . . . , C3n and D31, . . . , D3n). In the case of the implementation according to FIG. 17, these are 1 capacitor (C3) and n+1 diodes (D3 and D1, . . . , Dn). The first implementation has the better efficiency, as here fewer diodes are required in the output, while the second manages with fewer components.

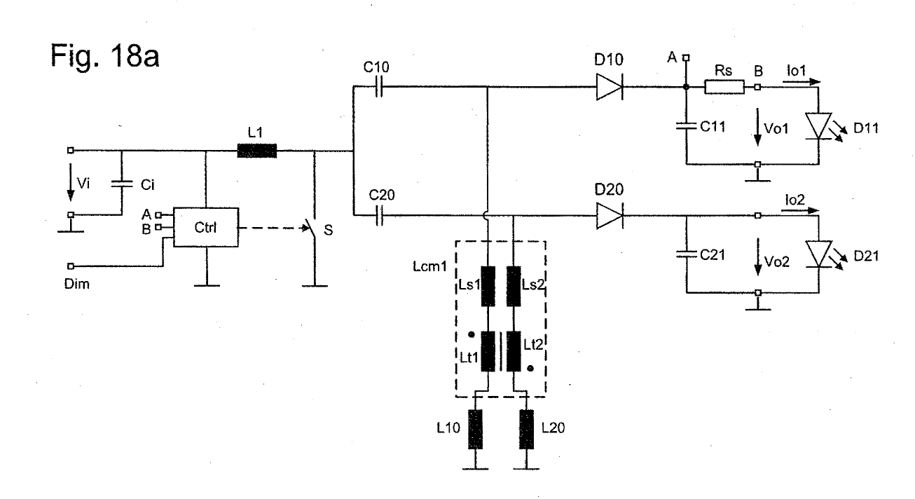

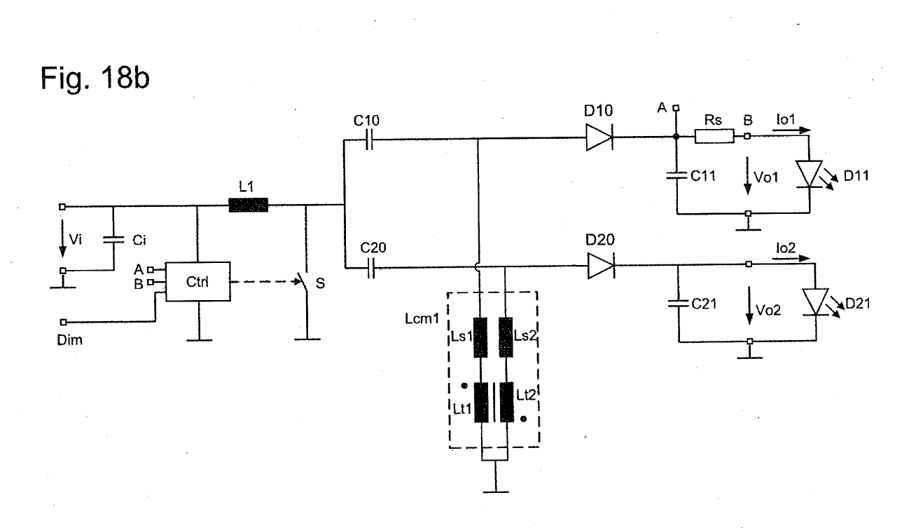

FIGS. 18a and 18b show two inventive embodiments based on the SEPIC converter concept, wherein in the version in FIG. 18b the leakage inductances Ls1 and Ls2 of the common mode choke jointly assume the function of the two inductors L10 and L20.

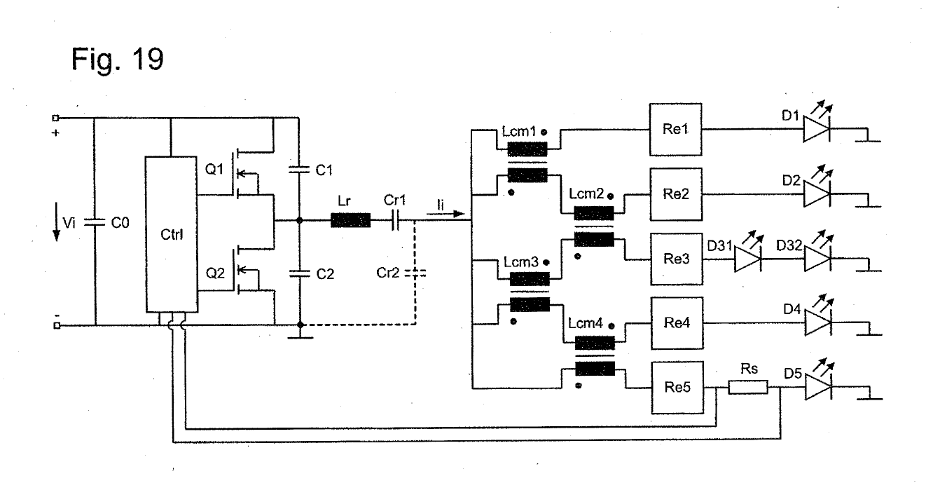

FIG. 19 shows an inventive implementation of an inverter, based on a soft-switching half-bridge circuit with resonant output circuit comprising Lr, Cr1 and the optional Cr2, which implements an alternating current source. The half-bridge is zero voltage switching. This alternating current source supplies an arrangement similar to that disclosed in FIGS. 8b to 8e.

Here the so-called “trapezoidal capacitors” C1 and C2 allow virtually zero-voltage turn-off of the transistors Q1 and Q2. The transistors Q1 and Q2 have a fixed, time-invariant duty cycle, i.e. are not controlled by pulse width modulation. This is selected such that Q1 and Q2 are never simultaneously conducting. The duty cycles of the two transistors need not be equally large. Thus Q1 can have a duty cycle of 60% and Q2 a duty cycle of 35%.

The current controller Ctrl uses the voltage dropped across the resistor Rs to set the required nominal current through the light emitting diode D5, and therefore through all the light emitting diodes, by varying the switching frequency of the transistors Q1 and Q2. This nominal current could be predefined, for example, by a higher-order controller of a light management system (not shown).

For reasons of clarity, an input filter (preceding the input capacitor Ci) for suppressing electromagnetic interference is not shown in FIG. 19. It is also omitted in all the subsequent circuits.

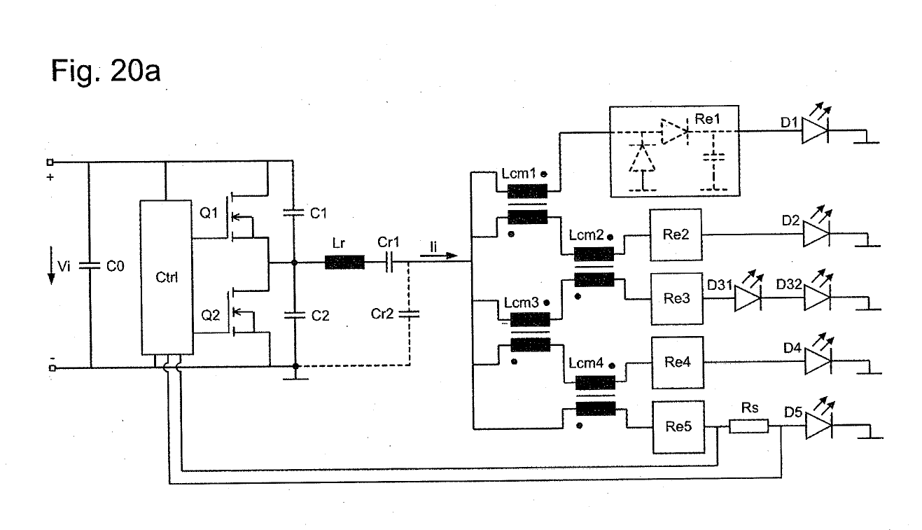

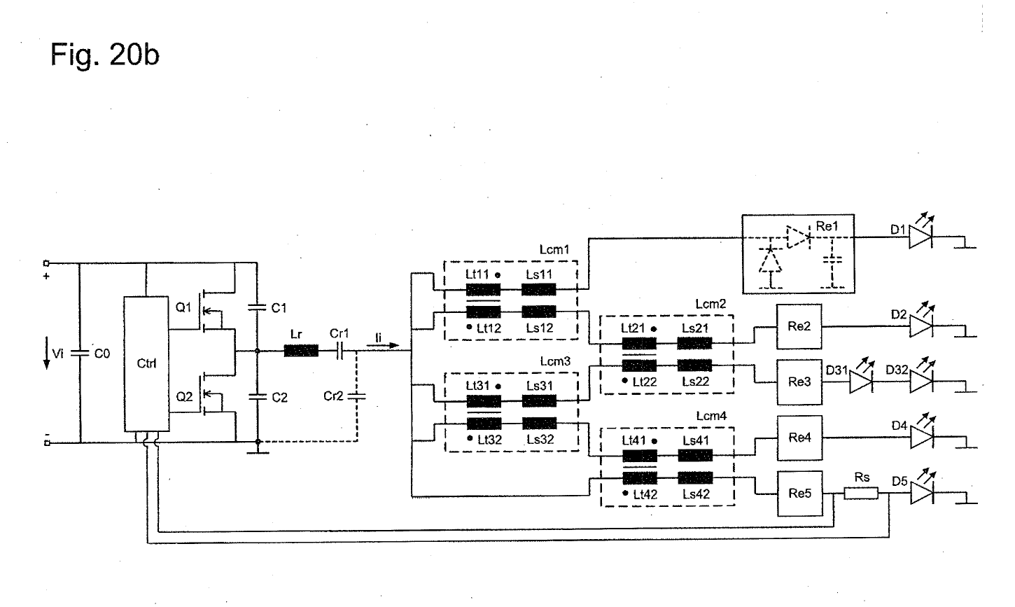

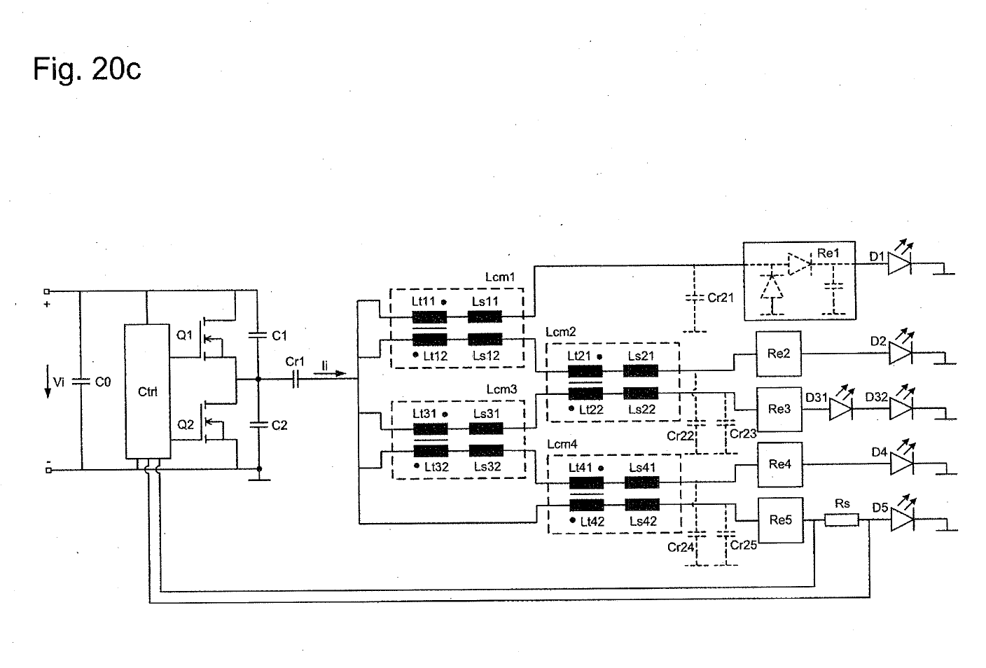

Because of the two capacitors Cr1 and Cr2, the current Ii flowing into the rectifier circuits Re1 to Re5 cannot have a DC component. It is therefore advisable to use only rectifier circuits which absorb a pure alternating current at their input. If such rectifier circuits are used, magnetic saturation of the common mode chokes Lcm1 to Lcm4 is reliably prevented. For example, rectifier cells based on the unbalanced voltage doubler circuit as shown in FIG. 2 can be used. An example incorporating these reverse-conducting rectifier circuits is shown in FIG. 20a.

FIG. 20b shows another representation of the inventive circuit according to FIG. 20a, wherein each common mode choke is replaced by an equivalent circuit consisting of a transformer and two leakage inductances Ls.

With appropriate dimensioning of the leakage inductances of the common mode chokes, the totality of the leakage inductances Ls can completely assume the function of the resonant inductor Lr, as shown in the modified implementation according to FIG. 20c. The effect of the optional resonant capacitor Cr2 is now achieved by the optional resonant capacitors Cr21 to Cr25. Because the leakage inductances of the common mode chokes are present anyway, a more inexpensive and more compact design can be implemented in this embodiment.

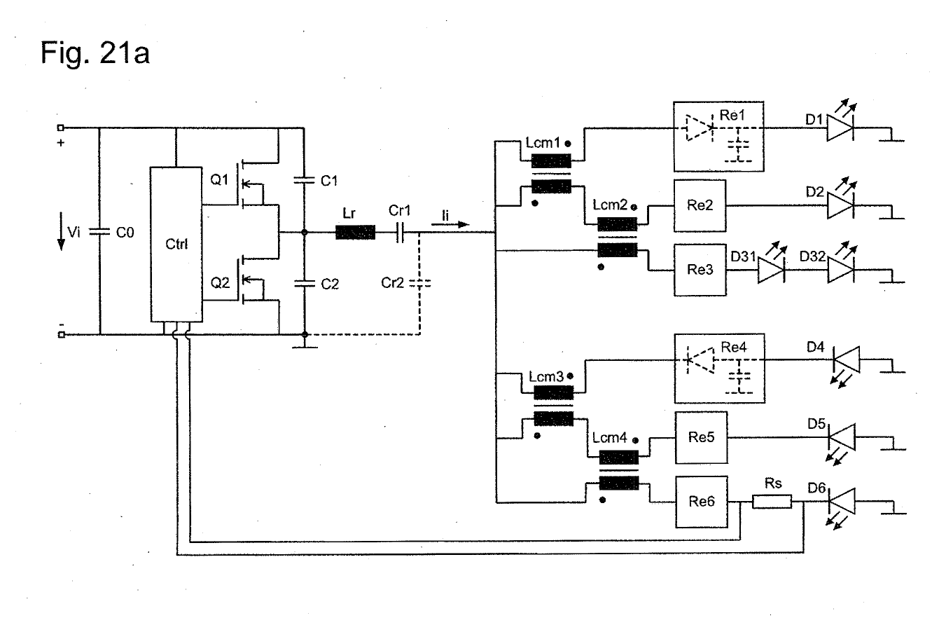

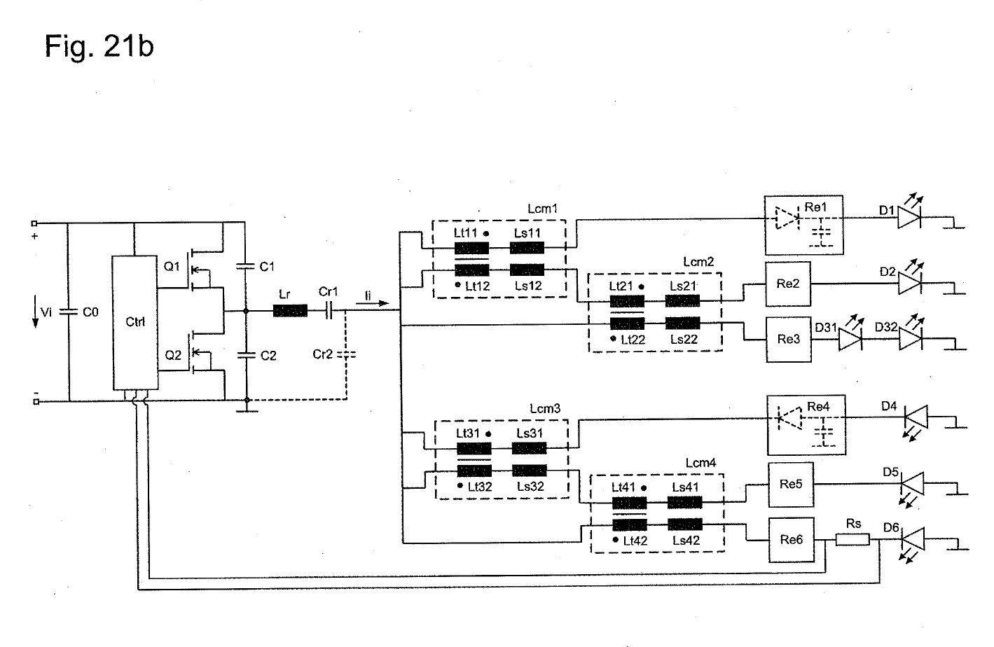

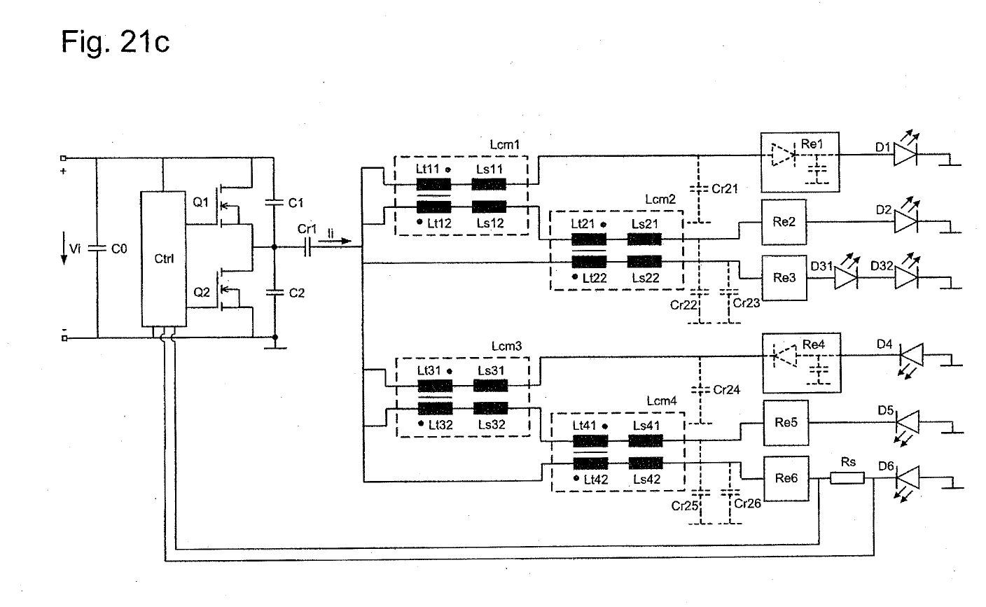

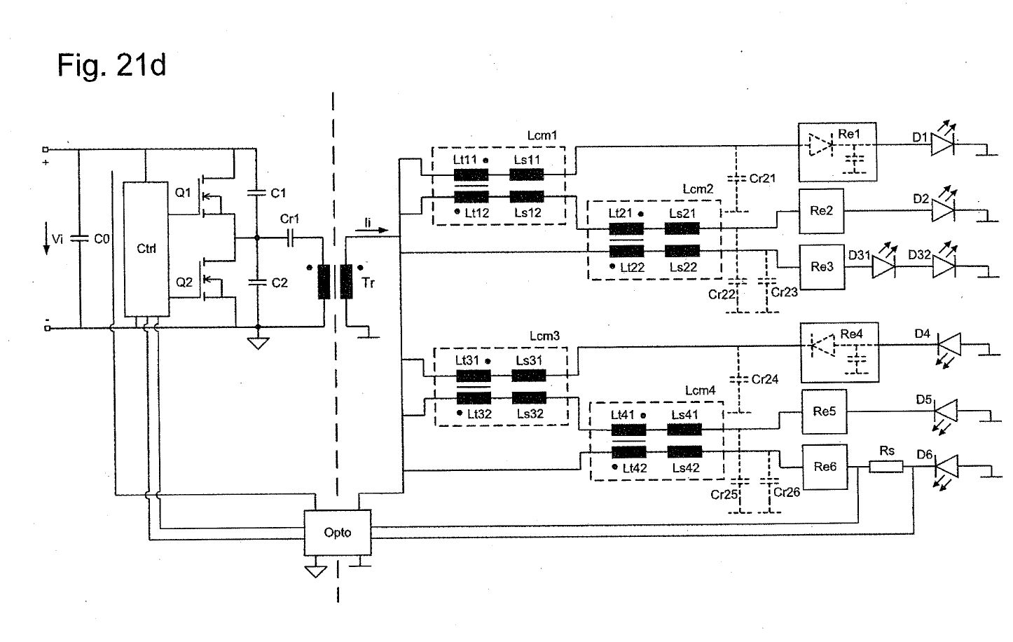

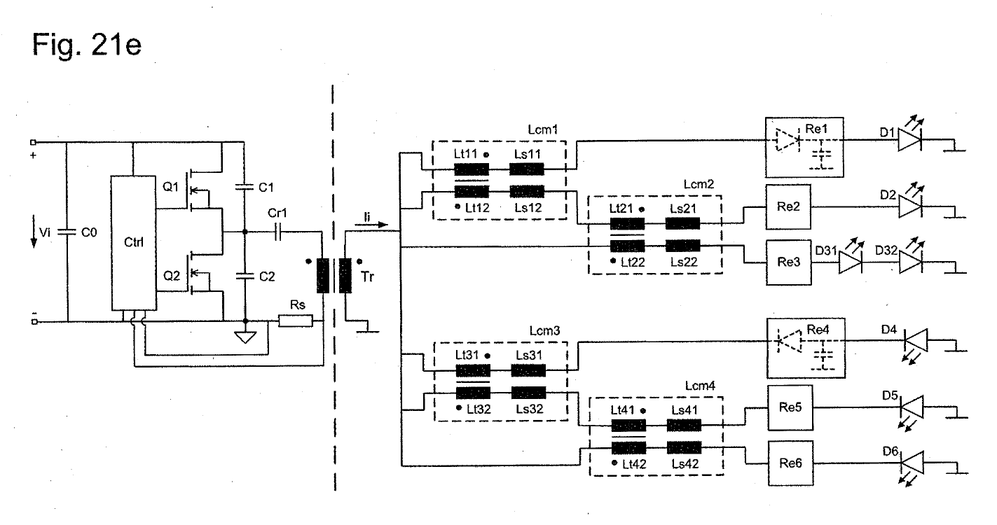

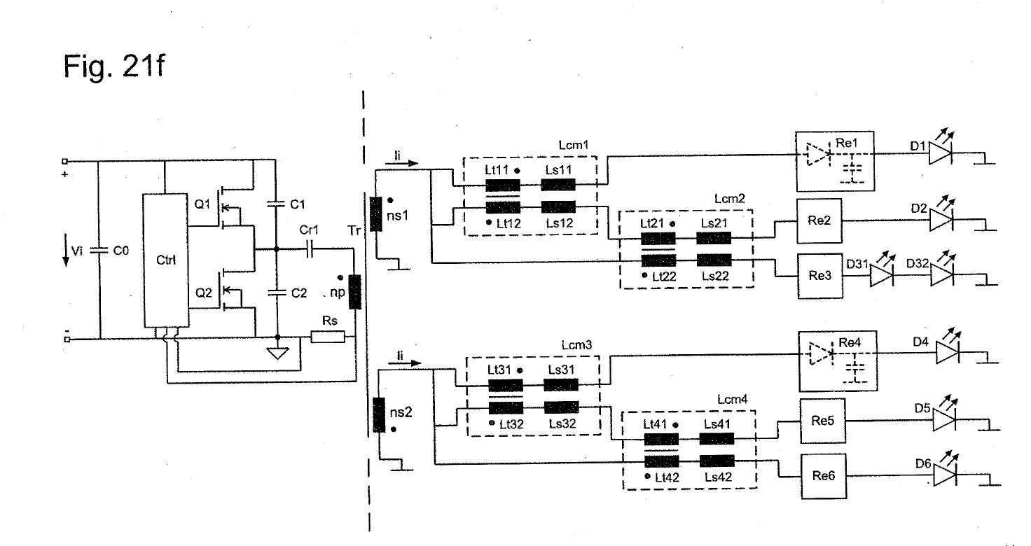

FIG. 21a shows a modified variant of the circuit according to FIG. 19 or 20a, which manages with reverse-blocking rectifier circuits. Said rectifier circuits are connected such that no DC component is caused in the current Ii, thereby ensuring that no DC current flows through the capacitors Cr1 and Cr2. By way of example, Re1 and Re4 are shown as half-wave rectifiers. Here Re1 to Re3 and Re4 to Re6 have the same input current direction or rather polarity as the diodes used. The advantage of this circuit variant is the symmetrical utilization of the two half-waves that is provided by the bridge circuit as well as the property that only n−2 common mode chokes are required to provide n outputs and fewer diodes are required for the reverse-blocking rectifier circuits than for the reverse-conducting rectifier circuits, thereby also providing higher efficiency in most cases.

The circuit in FIG. 21a has the disadvantage, however, that not all the light emitting diodes or light emitting diode strings can be connected to GND or the common reference potential using the same terminal, e.g. the cathode, with the result that, when using light emitting diodes of the same type, these are cooled with differing degrees of effectiveness. This is a major drawback particularly in the case of high-power light emitting diodes. It would therefore appear advisable to use the circuit according to FIG. 21a particularly for low-power light emitting diodes, e.g. radial light emitting diodes, or arrays thereof. In the case of high-power light emitting diodes, the use of two different light emitting diode designs could provide a solution, wherein first the cathode, then the anode has a particularly good thermal connection to the light emitting diode housing used. However, these two different versions require different light emitting diode chip patterns which generally, however, have different properties (e.g. color), which is often undesirable. In the typical case of a MAGGIE concept, however, two different colored light emitting diode types (mint and amber colored) are deliberately used, so that in such an application the circuit appears to be a reasonable choice. However, the two different light emitting diode types also have a different temperature behavior, in particular a color shift with temperature, so that the possibility of different operating currents occurring in both light emitting diode types appears desirable, which, however, is not possible for the circuit according to FIG. 21a without considerable complexity caused by appropriate additional circuitry. The assertion therefore holds that the circuit according to FIG. 21a appears advantageous primarily for low-power light emitting diodes.

FIG. 21b shows another representation of the circuit according to FIG. 21a, wherein each common mode choke is replaced by an equivalent circuit comprising a transformer and two leakage inductances Ls.

With appropriate dimensioning of the leakage inductances of the common mode chokes, the totality of the leakage inductances Ls can completely assume the function of the resonant inductor Lr, as shown in the modified implementation according to FIG. 21c. The effect of the optional resonant capacitor Cr2 is now achieved by the optional resonant capacitors Cr21 to Cr26. Because the leakage inductances of the common mode chokes are present anyway, a less expensive and more compact design can be implemented in this version.

FIG. 21d shows another advantageous further development similar to the circuit arrangement according to FIG. 21c, but now with transformer Tr which is used for galvanic isolation and/or for voltage adjustment. The leakage inductance of the transformer together with the totality of the leakage inductances Ls completely assume the function of the resonant inductor Lr where required. In order to provide galvanic isolation, the current measurement signal is accordingly transferred from the secondary-side to the primary-side section of the circuit by means of an optocoupler circuit Opto.

The complexity of the galvanically isolated transmission of the current measurement signal according to FIG. 21d is absent from the circuit according to FIG. 21e, as here the primary current of the transformer is measured instead of a light emitting diode current. Assuming that a transformer is used whose properties come very close to those of an ideal transformer, i.e. the transformer Tr must have a large magnetizing inductance and good coupling, the resulting error is negligibly small. To simplify the diagram, the optional capacitors Cr21 to Cr26 are not shown, even though these could also be used unchanged in this circuit.

FIG. 21f shows another advantageous further development similar to that in FIG. 21e, wherein the transformer Tr has two secondary windings ns1 and ns2. This circuit avoids the disadvantage that not all the light emitting diodes or light emitting diode arrays can be implemented with the same polarity with respect to the common reference potential, e.g. the heat sink. This circuit arrangement is therefore also suitable in particular for high-power light emitting diodes.

The magnetic components shown can be advantageously incorporated in one magnetic component, in particular in a ceramic component realized, for example, in LTCC technology.

The use of the leakage inductances is advantageous particularly if a plurality of functionally different magnetic components are integrated into one magnetic component, since, in comparison with conventional use of a plurality of discrete components, the integration here mostly results in relatively large leakage inductances which can now be advantageously utilized.

The design of the common mode choke is advantageously to be implemented such that it possesses a defined leakage inductance and the common mode choke does not go into saturation even at high currents. For this purpose, designs as described in EP 0 275 499 A1 or DE 36 21 573 A1 are advantageously used. For use for lighting purposes, a design as per DE 3621573 A1 in particular appears advantageous.

DE 36 21 573 basically achieves the same object as EP 0 275 499 A1: the implementation for a common mode choke having large additional leakage inductance for suppressing symmetrical (differential mode) interference is presented. In contrast to EP 0 275 499 A1, in DE 36 21 573 a separate “outer core” is not used for each “external” conductor, but only a single outer core for all. For this purpose two gapless toroidal cores are used for the common mode choke, wherein the first core is first provided with a winding over its entire circumference in order to obtain a weak external magnetic field. A second carbonyl iron powder core is placed concentrically over said first ferrite toroidal core. The second winding is then wound through the two toroidal cores with the same turns ratio and possibly somewhat thicker wire for equal copper resistances of the two windings. The selection of the core cross sections enables the nominal inductance of the common mode choke and the leakage inductance counteracting differential mode interference to be set separately from one another.

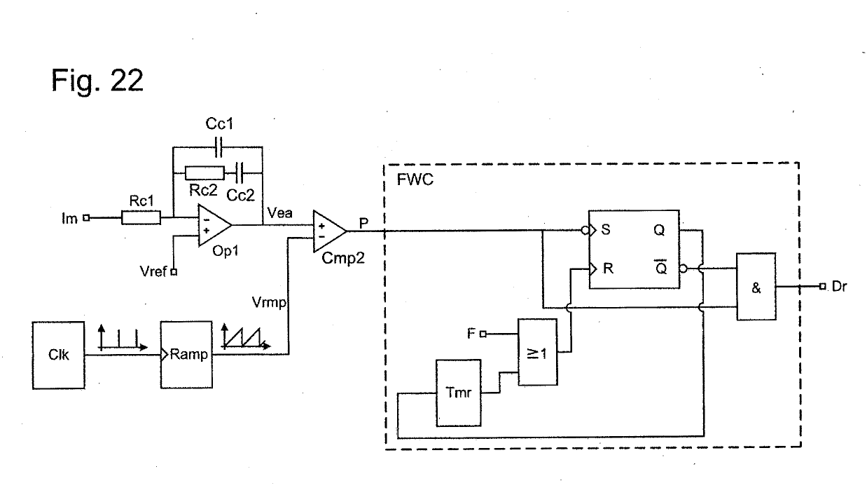

A first embodiment of the control system for the converter according to FIG. 10c is the pulse width modulation controller shown in FIG. 22. It provides fixed-frequency pulse width modulation. This controller consists of the error amplifier Op1 which generates the error signal Vea as a PID controller from the measured output current and the reference signal Vref associated with the nominal current. This signal is compared in the PWM comparator Cmp2 with a ramp voltage. In the case of a conventional pulse width modulation controller, the signal P generated would be fed to the gate driver Dry of the power switch. However, by means of the additional logic FWC, it is ensured that demagnetization of the common mode chokes takes place before Q1 can be turned on again, i.e. the on-time is if necessary curtailed by the freewheel signal F: if the actual PWM signal P goes Low, the RS flipflop is set by the falling edge. The RS flipflop “notices” that the circuit is in the demagnetization phase. If the PWM signal were to go High again in this phase, the AND gate would prevent the output Dr from going High. Only when the demagnetization signal is received in the form of the measurement signal F going High will the FF be reset via the R-input. In order to ensure reliable operation of the circuit, in particular reliable start-up of the circuit, the timer Tmr is provided, the time value of which corresponds to the maximum conceivable demagnetization time. If the FF is set for longer than this time, the output of the timer goes High and results in automatic resetting of the flipflop. If the additional logic FWC intervenes, this results in the control loop being opened and the actual controller Op1 operating at the limit, so that P becomes a maximum duty cycle signal. However, this opening of the control loop and the accompanying deviation of the required output current from the nominal value is accepted in order to be able to ensure balancing of the output currents.

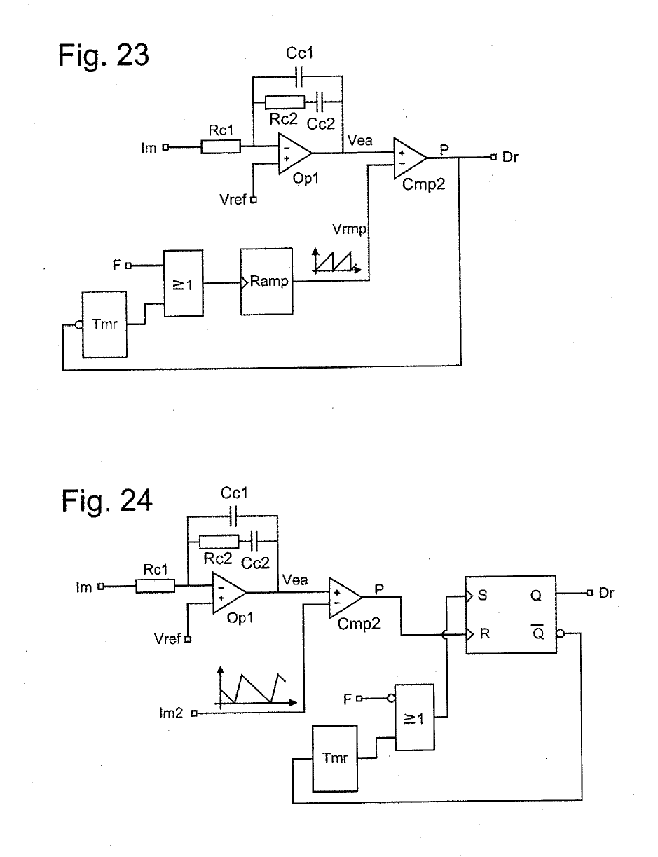

Instead of the controller according to FIG. 22, which provides fixed-frequency pulse width modulation, the controller shown in FIG. 23 can also be used for the circuit according to FIG. 10c, which controller ensures operation in boundary conduction mode, wherein neither the switching frequency nor the on- or off-time are constant. In contrast to the above embodiment, a variable switching frequency rather than a constant switching frequency is employed: as soon as the current through the choke reaches zero, the transistor is turned on again. The error amplifier and pulse width comparator are implemented by Op1 and Comp2 as in FIG. 22.

In the event of choke demagnetization, the Low-High transition of F causes the ramp generator Ramp to begin to generate a new ramp. This is compared with the error signal by the comparator Cmp2. The higher the error signal, the longer P or Dr remains in the High state and consequently Q1 remains turned on before Cmp2 goes to Low. A Low at Dr results in demagnetization of the chokes until such time as the demagnetization is confirmed by F re-transitioning from Low to High, resulting in a new ramp being generated.

In order to ensure reliable operation of the circuit, in particular reliable start-up of the circuit, the timer Tmr is provided, the time value of which corresponds to the maximum conceivable demagnetization time. If the output is Low for longer than this time, a new ramp is generated, and it is not waited any longer for F to transition from Low to High.

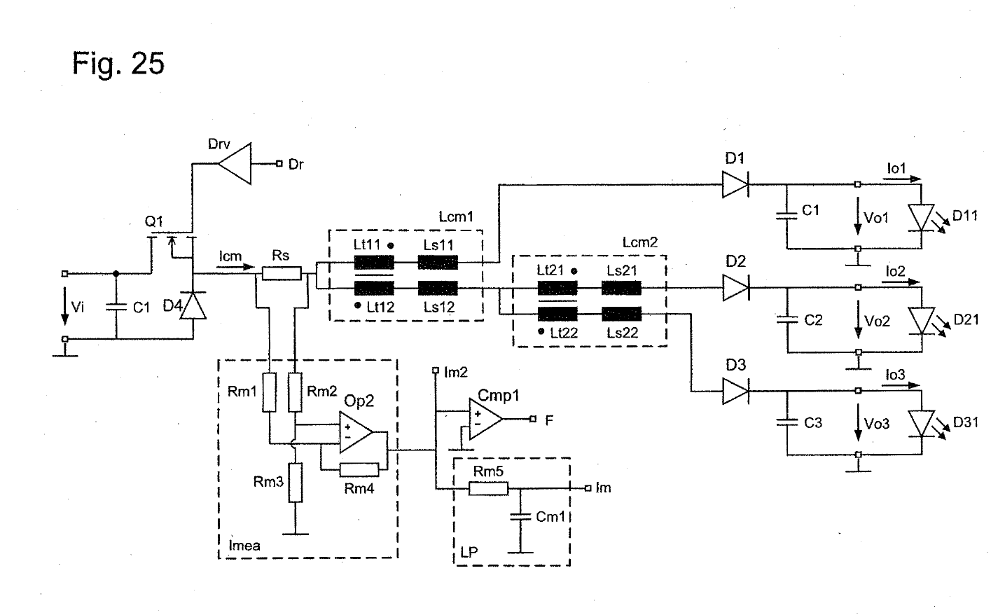

A controller based on the current mode control principle for the circuit according to FIG. 25 is shown in FIG. 24. This controller also implements boundary conduction mode operation.

The control amplifier Op1 produces at its output the signal Vea which is compared with the present current measurement value Im2. If the value of Im2 exceeds that of Vea, the High-Low transition of P results in resetting of the flipflop and therefore causes Q1 to be turned off. In the subsequent demagnetization phase, F initially remains High, as the present current value is greater than zero. If demagnetization has taken place, this results under some circumstances (because of a parasitic oscillation briefly causing Icm to go negative) in multiple toggling of the comparator Cmp1, wherein the High-Low transition of F causes the flipflop to be set and therefore Q1 to be turned on again. As also in the above circuits, an additional timer Tmr is provided which sets the flipflop after it has been in the unset state for a long time, thereby ensuring “start-up”

FIG. 25 illustrates another implementation of a buck converter having three outputs. In contrast to the circuit according to FIG. 10c, the current is now measured using the shunt Rs at the common input terminal of the current sharing network instead of at one of the outputs of the circuit. The current measuring device Imea is implemented by a differential amplifier which delivers a measurement signal proportional to the current Icm to be measured and referred to GND, because the signal Im2 corresponds to the appropriately amplified and ground-referred voltage drop across the shunt Rs. The time average of the voltage dropped across Rs corresponds to the time average of the sum of all the LED currents. In order to enable the control system to be provided with the time average of the output currents, the lowpass filter LP is present. As in the circuit according to FIG. 10c, the comparator Cmp1 is used to detect the demagnetization of the common mode chokes Lcm1 and Lcm2.

The circuits according to FIGS. 22, 23 and 24 can be used as the control circuit

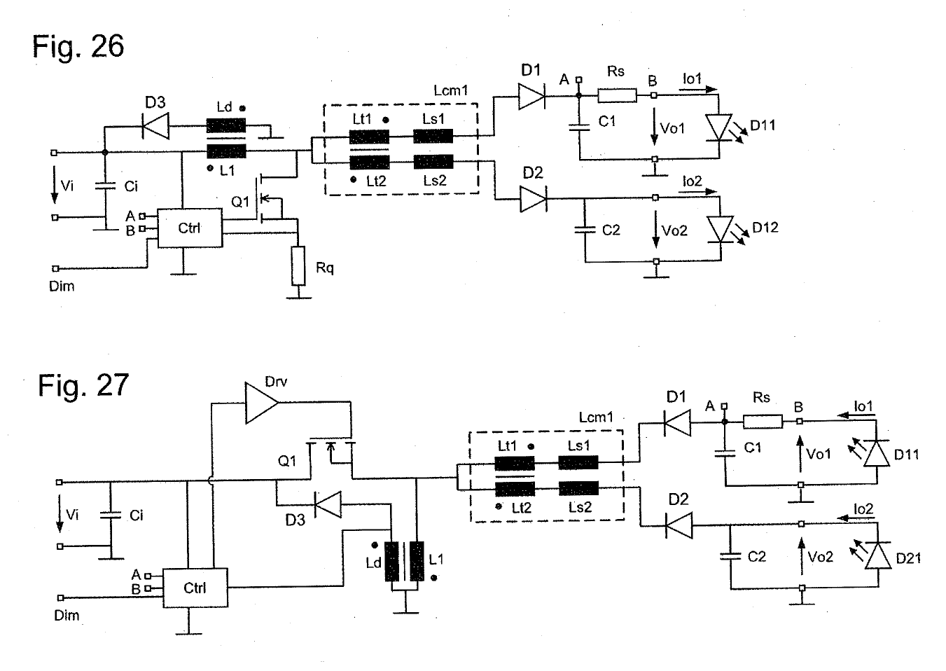

FIG. 26 shows a boost converter having two outputs. The actual boost converter consists of the storage inductor L1, the switching transistor Q1 and the diodes D1 and D2. As in the case of the buck converter described above, with a boost converter the control action can also be applied to one of the two output currents or to the current flowing into the input terminal of the current sharing network. In the circuit considered here, the control action is applied to one of the output currents. In addition, a subordinate current control loop can be used as a kind of “current mode control” which uses the switch current—detected using the resistor Rq—for control purposes.

The leakage inductances Ls1 and Ls2 of the common mode choke that can be advantageously used in the case of the buck converter are undesirable in the case of a boost converter, as they result in excessively high voltage peaks when the transistor Q1 turns off: Ls1 and Ls2 prevent the currents in the output circuits from being able to jump from 0 to the respective half current value of the inductor current through L1 at the turn-off instant of the transistor. A snubber network must therefore be provided which limits the switch voltage. This can be of dissipative design in the form of an RDC network in parallel with Q1, or consist of Ld and D3 as an optional clamping circuit for the transistor voltage and be non-dissipative. The clamping circuit shown limits the switch voltage immediately after the opening of Q1 to a value resulting from the transformation ratio of the transformer constituted by Ld and L1 and the input voltage. Ld and L1 must be magnetically coupled together as well as possible. Assuming that the input voltage is 10V and Ld comprises twice as many turns as L1, the transistor voltage would be limited to a value of twice the input voltage, i.e. 20V, as the diode D3 then begins to conduct and clamps the voltage across the transistor.

In contrast to the buck converter, in the case of the boost converter there is no limitation in terms of discontinuous and continuous operation, at least as long as the leakage inductances are negligibly small. Irrespective of the operating mode, while Q1 is turned on the common mode choke is demagnetized, the current through the common mode choke therefore becomes zero and, due to the subsequent blocking action of the two diodes D1 and D2, this state is maintained until the next time Q1 is turned off.

Therefore, in the case of the boost converter, none of the above described control circuits is required, because even when the converter is operating in continuous mode in respect of the inductor L1, because of the topology it is always ensured that the current sharing network is operated in discontinuous mode and consequently demagnetization of the common mode chokes in the network is always ensured.

As in the case of the buck converter, with the buck-boost converter appropriate monitoring or control is also required so as to reliably ensure demagnetization of the common mode chokes. FIG. 27 shows such a converter which, like the above described boost converter, contains an optional clamping circuit for the transistor voltage, comprising Ld and D3.

To detect demagnetization of the choke, different circuit variables can be used. Among other things, the current through L1 or the current flowing into the current sharing network can be measured. It can also be checked using two voltage measurements that the diodes D1 and D2 are blocking. An additional third winding can also be applied to each of the common mode chokes and it can then be evaluated that all these voltages have become zero. Alternatively, the voltage across the switching transistor can also be evaluated. After the original high value which is determined by the clamping circuit, during the demagnetization phase the voltage at the switch falls to the sum of the input voltage and the average of the absolute values of the two output voltages, then falling once again to the input voltage as soon as all the chokes have been demagnetized. This second fall in the switch voltage can likewise be used for detection.

In the embodiment according to FIG. 27, however, another detection possibility is used: for this purpose the voltage across the inductor Ld is used, because if this has fallen to zero, all the chokes are demagnetized and the switch Q1 can be turned on again from this time onward. Similarly to the above control circuits according to FIGS. 22 to 24, appropriate control circuits can also be implemented for the buck-boost converter.

The following figures consider another variant of current balancing for a plurality of branches. The current balancing is implemented by the series connection of a capacitor, an alternating current or rather AC voltage source and two oppositely connected, reverse conducting rectifier circuits each containing one or more light emitting diodes connected in series. Each of these circuit arrangements provides two ‘light emitting diode outputs’ referred to a common potential (e.g. ground). A plurality of these circuit arrangements can be used if more than two ‘light emitting diode outputs’ are required.

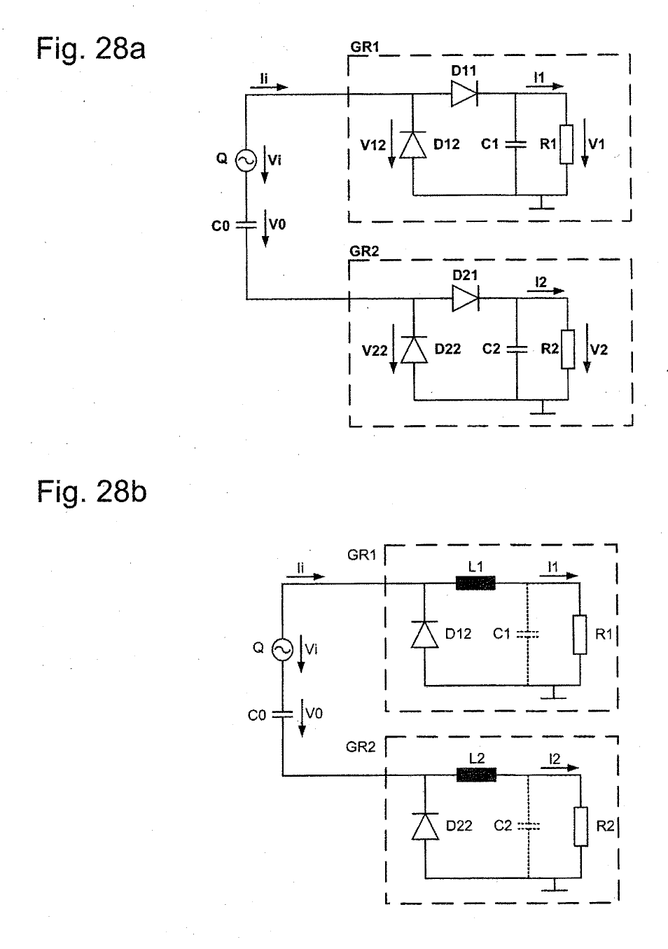

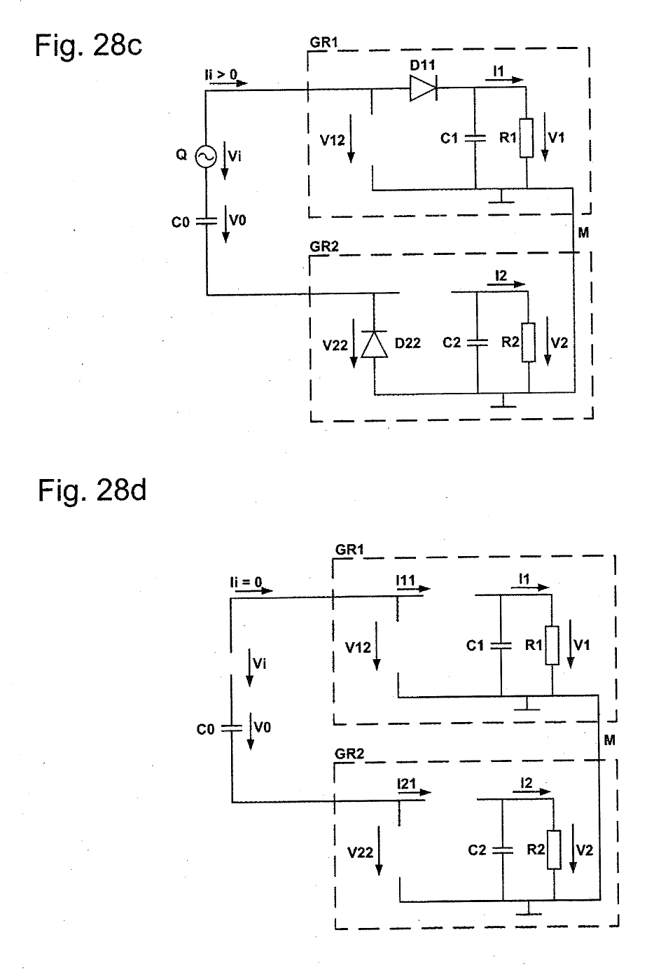

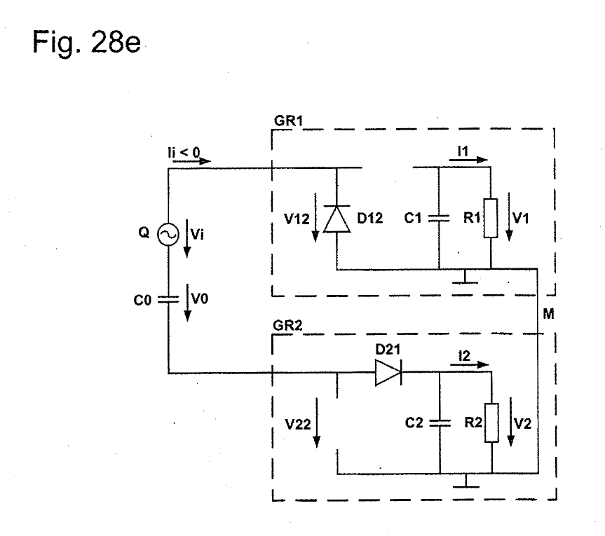

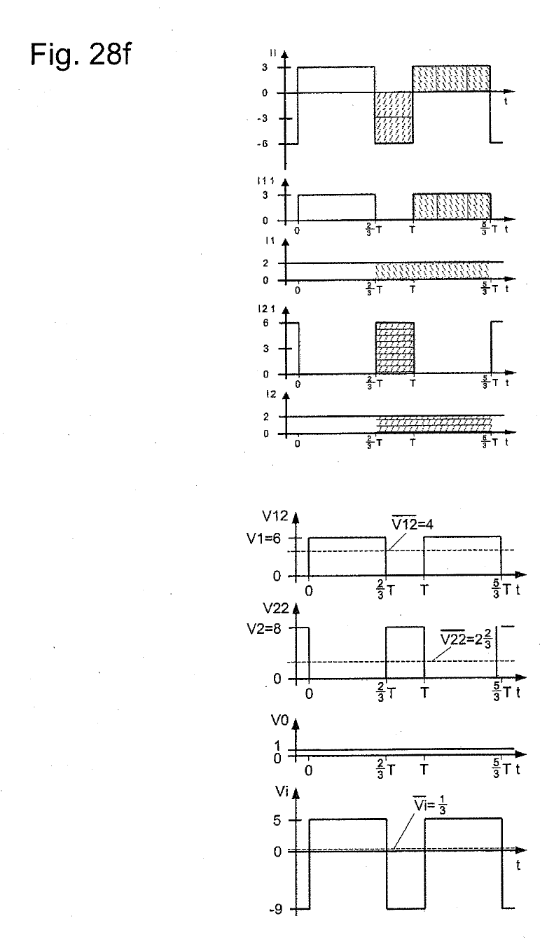

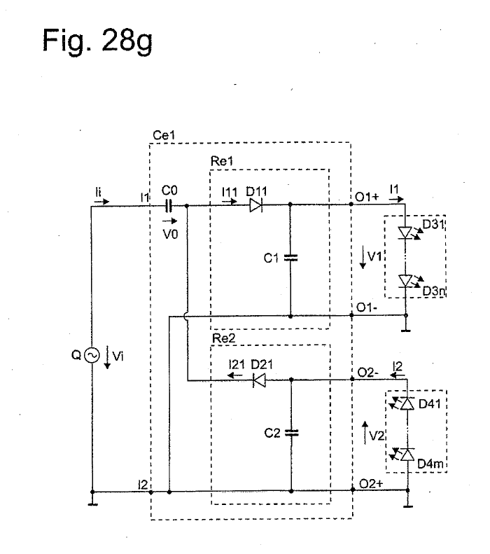

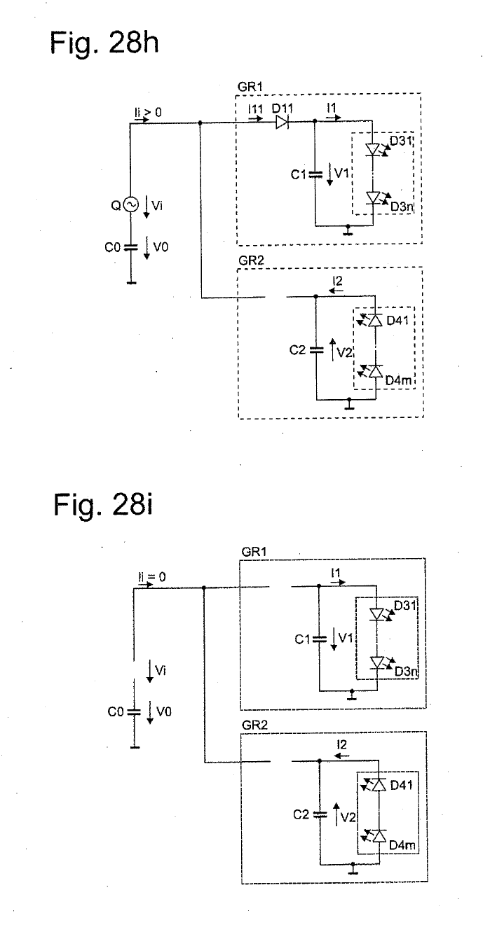

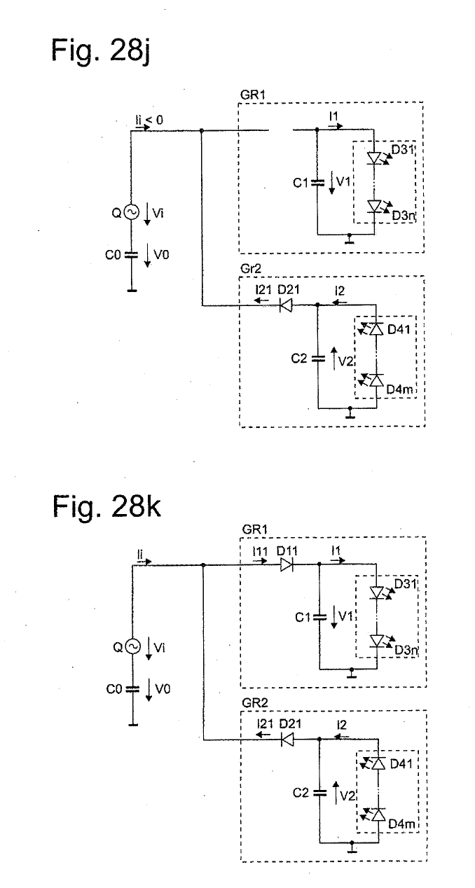

FIGS. 28a and 28b show embodiments of such circuit arrangements. The circuit types VVD and CD are depicted in the two figures. The circuit type VVD is based on a voltage doubling circuit and the circuit type CD is based on a simple current smoothing circuit.

The mode of operation of the circuit according to FIG. 28a is illustrated by the FIGS. 28c to 28e. To simplify the explanation it will now be assumed that all the components are ideal, i.e. in particular the diodes behave like ideal switches.

The source Q operates as a current source. If a positive current Ii is supplied by the source Q, FIG. 28c shows the functionally relevant components: the current Ii flows through the diode D11, is then split between C11 and R1 before then flowing back to the source via the ground connection M marked on the diagram to facilitate understanding, the diode D22 and the capacitor C0. The load R2 is supplied by the capacitor C2 during this time. The strength of the current Ii>0 only affects the load current I1, but not I2.

If no current Ii flows through the source Q, FIG. 28d illustrates that the loads R1 and R2 are supplied with energy by the associated capacitors C1 and C2 respectively. Because the capacitor voltages V1 and V2 are positive, the respective capacitor voltage across the two diodes D11 and D12 or D21 and D22 is split and all the diodes block.

FIG. 28e accordingly shows the relevant components in the case that the source Q delivers a negative current. Here the behavior of the two rectifiers is precisely the reverse: for Q, effectively only GR2 is now present, whereas GR1 is not visible. The strength of the current Ii<0 only affects the load current I2, but not I1.

Because of the capacitor C0, no direct current can flow through the source, i.e. Ii cannot have a DC component, as the capacitor C0 acts as a blocking capacitor or balancing capacitor. Because the positive component of the current Ii ultimately determines the load current I1 (as the positive component of Ii is blocked by D12, it must flow through D11, and as no direct current can flow through C1, the time average of the positive component of Ii must equally correspond to the time average of I1) and the negative component Ii determines the load current I2, the time averages of the load currents I1 and I2 must be equal. The two loads R1 and R2 are therefore operated with the same current (current balancing).

FIG. 28f shows typical current and voltage waveforms of the circuit according to FIG. 28a. For simplicity, square-wave current waveforms have been assumed. For the illustration a duty cycle of 2:1 has been assumed.

For the representation of the voltages occurring in the lower half of the diagram, in addition to the assumption of ideal components, ideal smoothing of the load currents is assumed, which means infinitely large capacitances C1 and C2, so that the output voltages V1 and V2 have no ripple. It has also been assumed that no time periods with Ii=0 occur. Two different sized loads with R1=3 ohms and R2=4 ohms are assumed. This produces the output voltages V1=I1*R1=2*3=6V and V2=I2*R2=2*4=4V, as well as the illustrated responses of V12, V22, V0 and Vi.

If the mesh {ground-D12-Q-C0-D22-ground} is considered, the following mesh equation must be fulfilled:

V12(t)=Vi(t)+V0(t)+V22(t).

FIG. 28f shows that this equation is fulfilled at each point in time, and therefore also for the dashed-line time averages plotted (marked with overbar). The alternating current or rather AC voltage source is advantageously constituted by the secondary winding of a transformer, as this is a particularly simple means of producing a floating source.

FIG. 28g shows the block diagram of a circuit arrangement for balancing the two load currents I1 and I2 by the DC voltage V0 appearing across the capacitor C0 in the supply voltage path in the case of a reverse blocking rectifier GR1 and a forward blocking rectifier GR2 with single voltage output (circuit type VD) connected in parallel. The capacitor C0 suppresses a DC component in the supply current Ii. As Vi is a pure AC voltage source, the sum of the voltage across the AC voltage source Vi and the voltage across the capacitor C0 may contain a DC component. This component corresponds to the actual voltage difference of the two rectifiers GR1 and GR2. As one rectifier is forward blocking and the other rectifier is reverse blocking, each rectifier is supplied with a half-wave of the alternating current Ii in each case. Due to the DC component of the voltages Vi+V0, a different power is also permitted in the two operating sections, so that the current in both sections can be equally large. For example, if the current I11 in the first operating section were to become greater on average than the current I21 in the second operating section, the capacitor C0 would discharge and the voltage V0 would fall, so that the voltage V1 would also fall and the voltage V2 would increase in absolute terms, which counteracts the differential current flow and therefore balances the current magnitudes.

FIG. 28k shows the block diagram of a circuit arrangement for balancing of the two load currents I1 and I2 by the DC voltage V0 appearing across the capacitor C0 connected between the voltage source and the reference potential in the case of one reverse and one forward blocking rectifier with single voltage output (circuit type VD) connected in parallel. The operation of this circuit arrangement is identical to that of the circuit arrangement according to FIG. 28g. Here the capacitor C0 is merely inserted in a different part of the current path. However, this does not affect the operating principle.

FIG. 28h shows the phase diagram of FIG. 28k for the case Ii>0, FIG. 28i shows the phase diagram of FIG. 28k for the case Ii=0, and FIG. 28j shows the phase diagram of FIG. 28k for the case Ii<0. The blocking diodes are indicated by a line break, the conducting diodes are shown correctly. In the case Ii=0, the voltage source is indicated by another line break.

If more than two light emitting diode outputs are required, there are advantageously used:

a) a plurality of transformers connected in series on the primary side which have characteristics that are as ideal as possible particularly in the case of markedly different loads or more specifically light emitting diodes,
b) a transformer having a plurality of secondary windings, and, particularly in the case of markedly different loads or more specifically light emitting diodes, additional common mode chokes which balance the secondary currents,
c) a combination of a) and b).

On the primary side, the transformer is controlled by one of the usual power electronic circuits, such as a half-bridge, full-bridge, push-pull or class E converter. This is advantageously a soft-switching circuit based on the ZVS or ZCS principle.

Incorporation of a plurality of inductive components (transformers, common mode chokes or a combination of such components) into one component appears particularly advantageous because of the possible reduction in the size of the unit as well as in the complexity in terms of manufacture, testing and procurement. Particularly in the case of circuit type CD, the required inductors (e.g. L1, L2 in FIG. 2b) can likewise be jointly incorporated (e.g. with the required transformer). Incorporation of the balancing capacitors (e.g. C0) with magnetic components in one possibly monolithically integrated component e.g. in LTCC technology is possible and could provide a further size and cost reduction depending on the application and the requirements placed on the product (e.g. automotive application).

The rectifier switches can be implemented as synchronous rectifiers. In particular, the transformers present anyway in the circuit can be used for controlling the semiconductor switches of the synchronous rectifier.

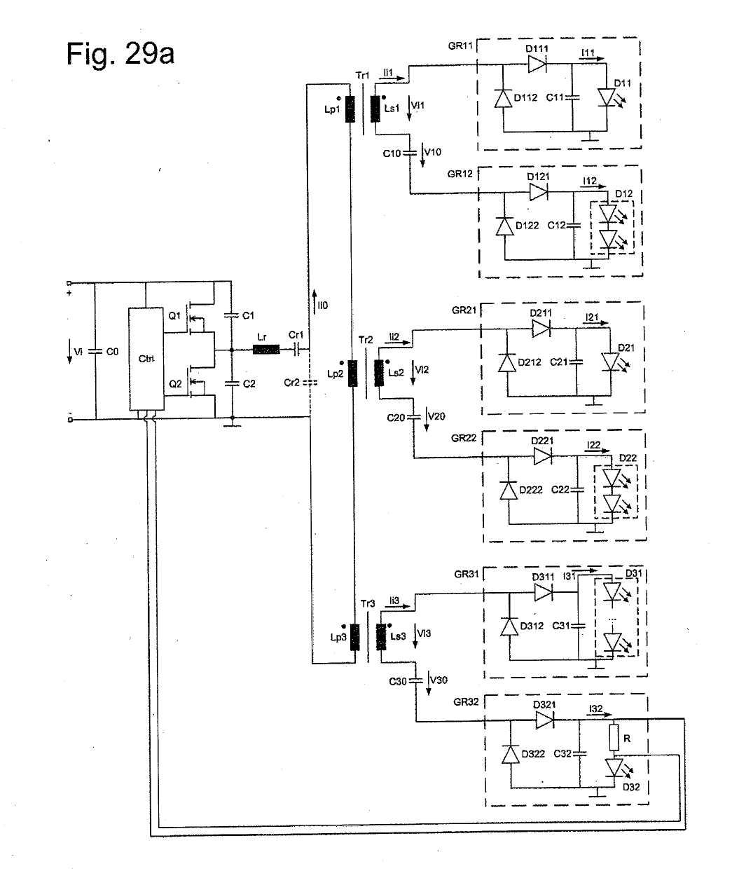

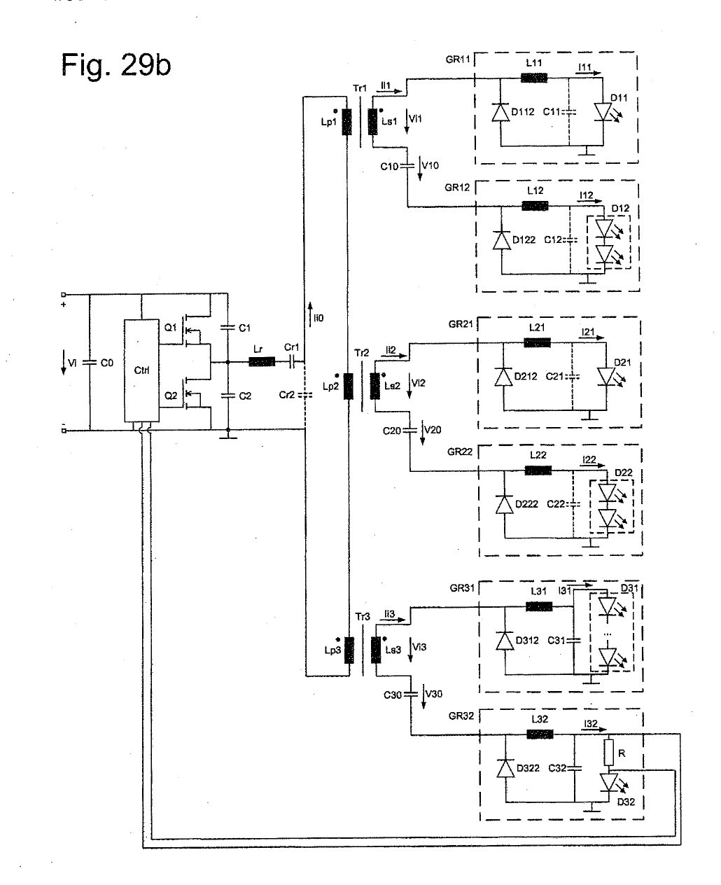

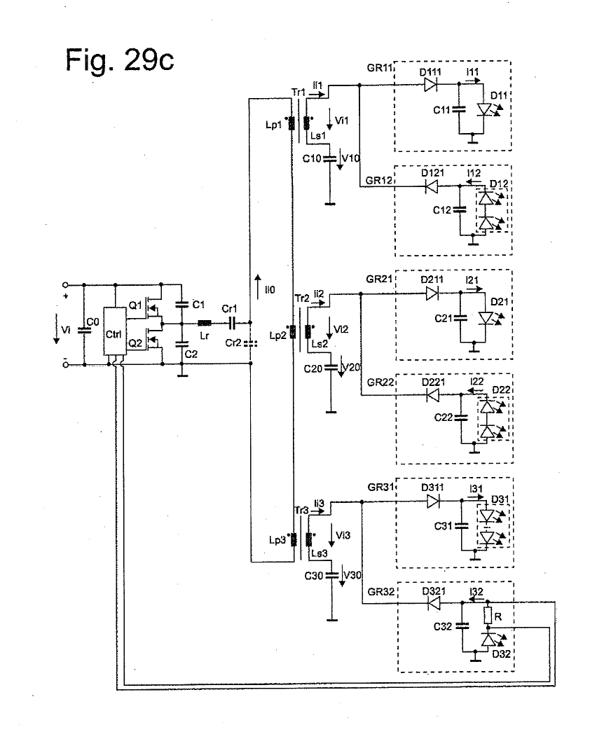

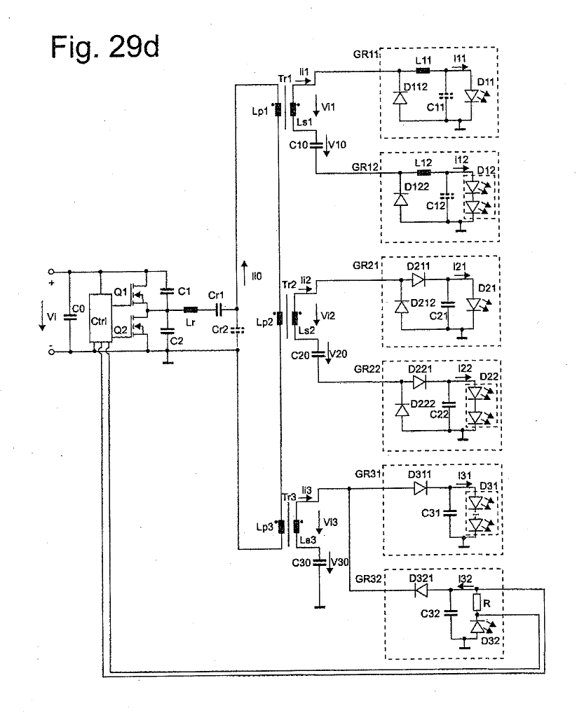

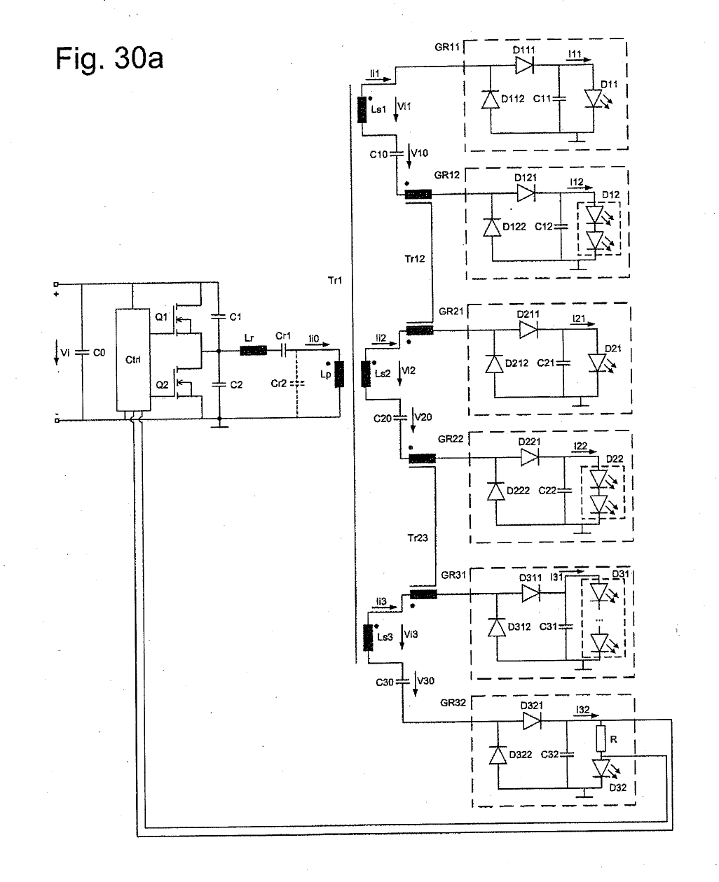

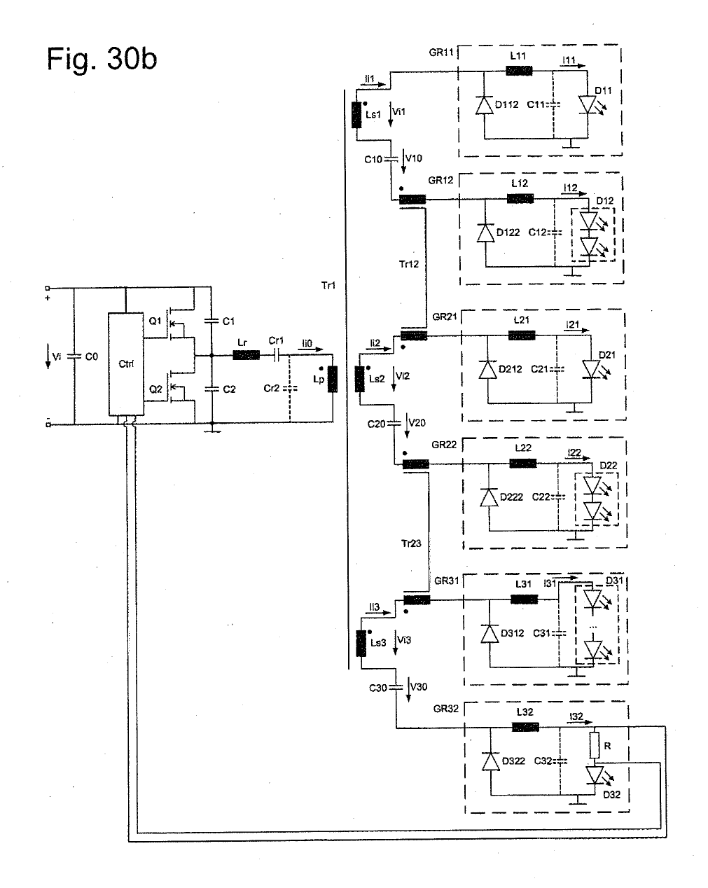

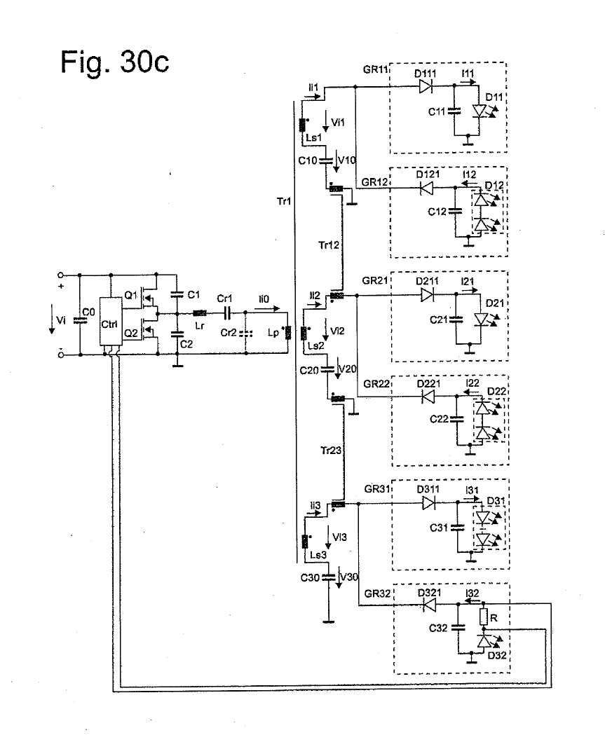

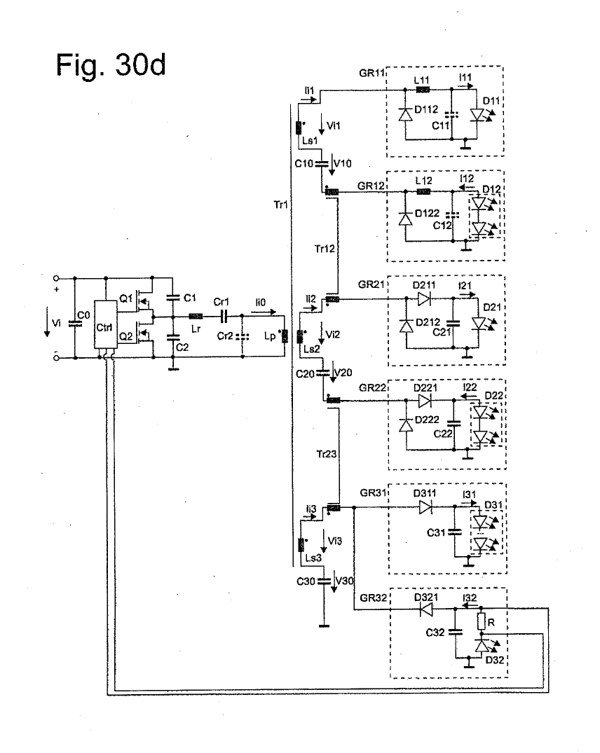

FIGS. 29a, 29b, 29c and 29d and FIGS. 30a, 30b, 30c and 30d show a circuit design in which in all cases a ZVS operated half-bridge supplies a plurality of light emitting diodes or light emitting diode strings with the same current. The capacitor Cr2 may be present depending on the design. In FIGS. 29a, 29b, 29c and 29d, in accordance with the listing under point a) above, a plurality of transformers are used, while the FIGS. 30a, 30b, 30c and 30d specify a circuit according to point b) in each case. The circuits according to FIGS. 29a, 30a are based on circuit type VVD (similar to FIG. 28a), while the circuits according to FIGS. 29b, 30b are based on circuit type CD (similar to FIG. 28b). The FIGS. 29c and 30c show circuits that are based on circuit type VD similar to FIG. 28k, while FIG. 29d shows a mixed form in which each group of two rectifiers connected to a secondary winding of a transformer Tr1. Tr3 operates according to one of the above described circuit types, the group connected to transformer TR1 according to circuit type CD, the group connected to transformer TR2 according to circuit type VVD, and the group connected to transformer TR3 according to circuit type VD. In the case of FIG. 30d, the situation is similar to FIG. 29d, except that a common transformer having one primary winding and three secondary windings is used, wherein the group connected to the first secondary winding (from the top) operates according to circuit type CD, the group connected to the second secondary winding according to circuit type VVD, and the group connected to the third secondary winding according to circuit type VD.

In all the Figures, light emitting diodes or light emitting diode strings have been shown as loads of the rectifiers GR with cathode connected to GND. This need not necessarily be the case—with appropriate circuit adaptation the anode can also be connected to GND. This could be advantageous particularly if the housing of the LEDs used are each connected to the anode of the LED chip, as all the LED housings can then be connected to a common electrically grounded heat sink, resulting in particularly good cooling of the light emitting diodes.

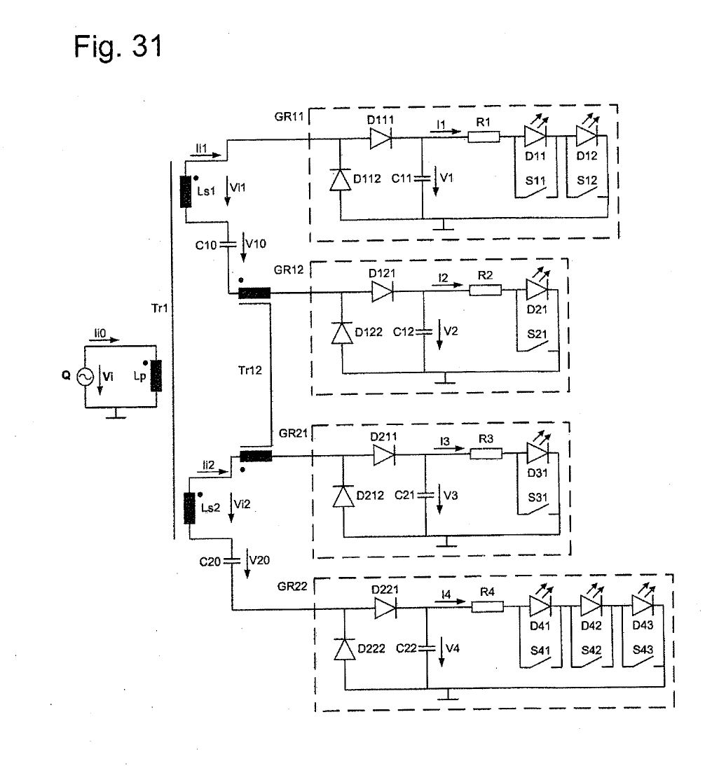

FIG. 31 shows a circuit design in which a transformer having two secondary windings, corresponding to point b) in the above listing, is used to operate 4 light emitting diode outputs. The balancing of the two secondary currents is ensured by means of the common mode choke Tr12. For dimming of the LEDs, the electronic switches S11 to S41 are controlled using a PWM signal. Table 1 below shows the ratios for 0% or 100% duty cycle of the switches.

A function generator with f=50 kHz is used as signal source Q. The resistors R1 to R4 are required for current measurement, but not for actual operation. The following components are used:

Tr1: transformer 1:1:1, Lp=Ls1=Ls2=1 mH, fres=750 kHz, RDC<1R0
Tr12: common mode choke EPCOS B82721-K2701-N20, 2×10 mH, 2×0R60 typ. RDC
All diodes: SS34 (3 A, 40V, Schottky)

### White Light Emitting Diodes

All capacitors: 1 OuF, 25V, X7R, TDK

### R1 . . . R4: 10 R, 1%, 0805

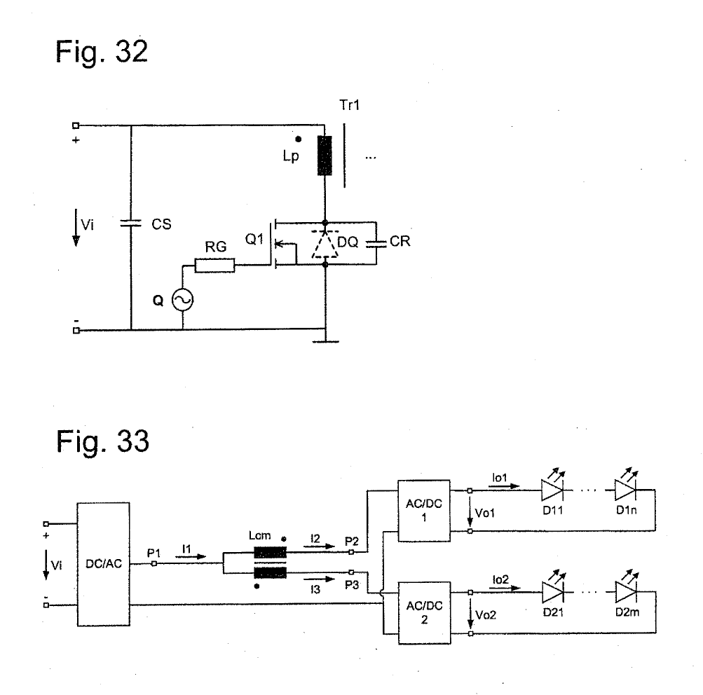

FIG. 32 shows the “front” part of the circuit according to FIG. 31, but now with a class E converter used as generator. This has the advantage of only requiring a single power transistor Q1 and, in addition, the latter is operated with ZVS (zero voltage switching). Contrary to the usual disadvantage of the class E converter of requiring a very high switch peak voltage with other circuit topologies, this disadvantage is somewhat mitigated here, as the rectifiers or rather the light emitting diodes, because of their nonlinear behavior, produce a flattening of the drain excursion, so that a transistor with lower maximum permissible drain voltage can be used than would be expected for a comparable resistive load.

The measured values in Table 1 were also able to be measured similarly using this source. The following components were used:

### Q1: IRFR110

DQ: not installed (optional if a MOSFET is used as Q1, as then if not installed then assumes the body diode function; essential if Q1 is a bipolar transistor or IGBT)

### RG: 10 R, 1%, 0805

### CR: 1 nF, 100V

### CS: 1 OuF, 25V, X7R, TDK

| | | | | | | | | Measured values | | | | | | | | | |
|---|---|---|---|---|---|---|---|---|---|---|---|---|---|---|---|---|---|
| Bridged light emitting diodes | | | | | | | | | | | | U_C10 | U_C20 | | | | |
| Q11 | Q12 | Q21 | Q31 | Q41 | Q42 | Q43 | Σ | V1 [V] | V2 [V] | V3 [V] | V4 [V] | [V] | [V] | I1 [mA] | I2 [mA] | I3 [mA] | I4 [mA] |
| 1 | 0 | 1 | 1 | 1 | 0 | 0 | 4 | 2.796 | 2.801 | 2.756 | 2.911 | 0.0015 | −0.1 | 0.04 | 0.04 | 0.03 | 0.07 |
| 1 | 0 | 1 | 1 | 1 | 0 | 0 | 4 | 3.396 | 3.456 | 3.451 | 3.418 | −0.0071 | −0.0057 | 1.28 | 1.27 | 1.25 | 1.31 |
| 1 | 0 | 1 | 1 | 1 | 0 | 0 | 4 | 3.777 | 3.844 | 3.856 | 3.79 | −0.0153 | 0.04 | 8.22 | 8.21 | 8.18 | 8.26 |
| 1 | 0 | 1 | 1 | 1 | 0 | 0 | 4 | 4.581 | 4.663 | 4.754 | 4.565 | −0.024 | 0.177 | 33.20 | 33.21 | 33.16 | 33.27 |
| 0 | 0 | 1 | 1 | 1 | 1 | 0 | 4 | 0.3337 | 4.654 | 4.745 | 8.919 | −2.138 | −1.99 | 33.30 | 33.00 | 32.98 | 33.00 |
| 0 | 0 | 1 | 1 | 1 | 1 | 1 | 5 | 0.2297 | 4.341 | 4.469 | 12.36 | −2.002 | −4.08 | 22.92 | 22.61 | 22.67 | 22.57 |
| 0 | 0 | 1 | 0 | 1 | 1 | 1 | 4 | 0.3387 | 4.674 | 0.3386 | 13.09 | −2.154 | −6.55 | 33.79 | 33.53 | 33.81 | 33.47 |
| 1 | 0 | 1 | 0 | 1 | 1 | 1 | 5 | 4.308 | 4.381 | 0.2435 | 12.44 | 0.0425 | −6.31 | 23.95 | 23.97 | 24.31 | 23.92 |
| 1 | 0 | 1 | 1 | 0 | 0 | 0 | 3 | 4.185 | 4.253 | 4.357 | 0.2027 | −0.3698 | 2.22 | 19.90 | 19.92 | 19.88 | 20.21 |
| 0 | 0 | 1 | 1 | 0 | 0 | 0 | 2 | 0.2161 | 4.298 | 4.412 | 0.2166 | −2.043 | 2.16 | 21.58 | 21.37 | 21.34 | 21.60 |
| 0 | 0 | 1 | 0 | 0 | 0 | 0 | 1 | 0.2482 | 4.401 | 0.2476 | 0.2486 | −2.077 | 0.0028 | 24.77 | 24.55 | 24.73 | 24.79 |

The Figures consider a third current balancing variant.

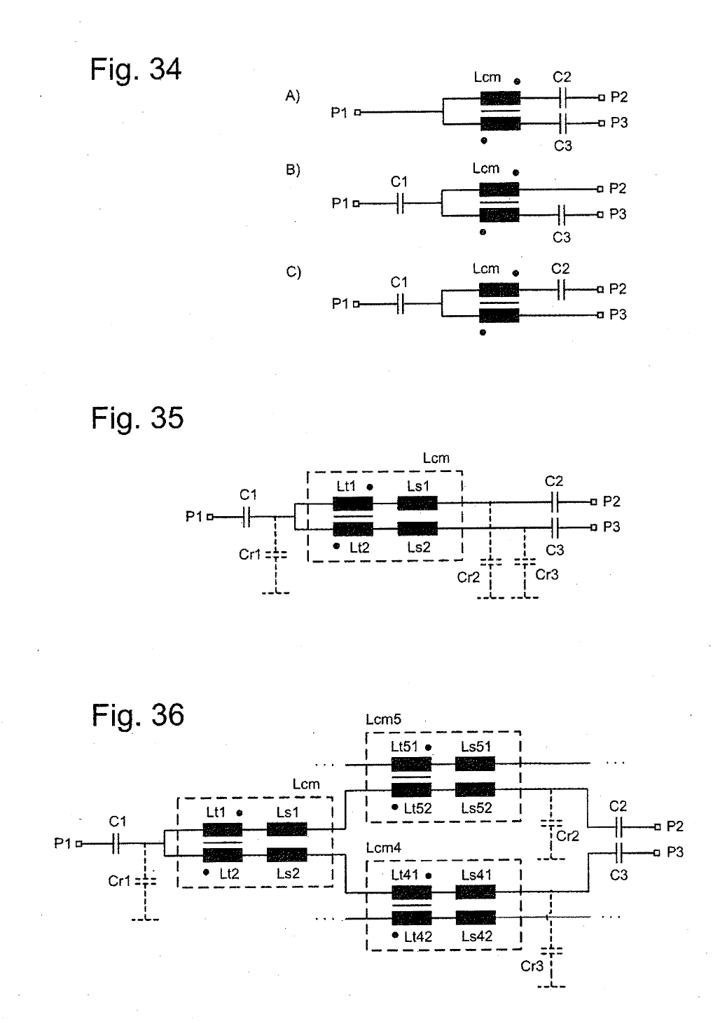

Also in this embodiment, quasi-parallel operation of a plurality of light emitting diodes and/or a plurality of LED strings using a DC/DC converter is proposed, wherein the magnitudes of the current flowing through the light emitting diodes are virtually identical. Control must be applied merely to the current in a light emitting diode or in a string of light emitting diodes. The converter has a current sharing network containing one or more common mode chokes in a basic configuration according to FIG. 1. In order to be able to guarantee the required operation of the current sharing network, it is proposed to augment the current sharing network with capacitors so as to produce resonant cells comprising common mode chokes and capacitors, as shown in FIGS. 34 to 36. The additional capacitors prevent DC current flowing through the common mode chokes, so that only alternating current flows through the common mode chokes which, at least at each zero crossing of the current, allows complete demagnetization of said chokes, this being critically important for the operation thereof.

If the currents through all the windings of the common mode chokes periodically return to zero, this results in the desired good balancing of the light emitting diode currents, as the common mode chokes in the current sharing network then operate in the desired manner. The operating basis of common mode chokes is that each choke winding has very high impedance. As the result of corresponding current flows in both windings, the generated magnetic fluxes in the core and therefore the high impedances cancel each other out. For proper operation of a common mode choke, high inductance values of the windings are therefore required, for which reason cores consisting of highly permeable material without air gap are normally used which cause relatively low saturation currents. In order to prevent saturation of the magnetic core of the common mode choke because of a sustained direct current, a periodic no-current state of the two windings is inventively realized.

The hitherto described current balancing using common mode chokes is particularly applicable if a periodic flow of current is present or is generated which—as already explained—consistently returns to zero. Numerous switched power electronic circuits can produce such current flows. For example, the alternating current source shown in the previous Figures can be implemented by any inverter. This is followed by rectifiers in order to supply the light emitting diodes with direct current having minimal ripple.

FIG. 33 shows such a basic converter arrangement having a common mode choke Lcm as current sharing network and which can be regarded as a DC/DC converter. Diverse types of DC/DC converters based on step-up and/or step-down converter concepts are known which can be modified using current sharing networks for operating light emitting diodes.

According to the invention, converter structures are used which have no DC path through the common mode choke, i.e. the arithmetic mean values of the currents Icm1 and Icm2 in FIG. 1 are zero by virtue of appropriate circuit design. In particular, at least 2 capacitors each connected in series with one of the three terminals of the common mode choke are used as DC eliminating components. In other words, the inventive implementation has one of the possibilities A) to C) shown in FIG. 34 as an integral part of the converter.

The resonant cells shown in FIG. 34 contain at least 2 capacitors, can form part of the inverters or rectifiers and, in addition to a DC suppressing function, can undertake other functions in the associated inverter or rectifier. In a half-bridge inverter, the capacitor can serve as a resonant capacitor. In rectifiers of the unbalanced doubler or cascade circuit type, this capacitor is the input capacitor, i.e. the first capacitor of the oscillating column.

The combining of the possibilities A) to C) from FIG. 34 is illustrated in FIG. 35, wherein the common mode choke is represented by the equivalent circuit comprising two tightly coupled (having a coupling factor of one) inductances Lt1 and Lt2 and the two leakage inductances Ls1 and Ls2. One of the two capacitors C1 to C3 can—as already described above—be omitted without affecting the inherent absence of direct current through the two windings of the common mode choke. Nor is this absence of direct current affected by any other capacitors that may be inserted in the circuit. Thus FIG. 35 shows other optional capacitors Cr (dashed lines) which are shown connected to ground by way of example. These capacitors are advantageously resonant capacitors which act in conjunction with the leakage inductances Ls1 and Ls2 and can be used, for example, for soft switching within the converter.

Other variants of the resonant cells (also known as “building blocks”) are permissible provided that absence of direct current is ensured. Therefore, as well as additional capacitors, any components can be connected in series with the windings of the common mode choke and the capacitors. In particular, it is advisable to connect the windings of one or more additional common mode chokes in series if the converter is to have more than two outputs. FIG. 36 shows a practical instance of a very common building block.

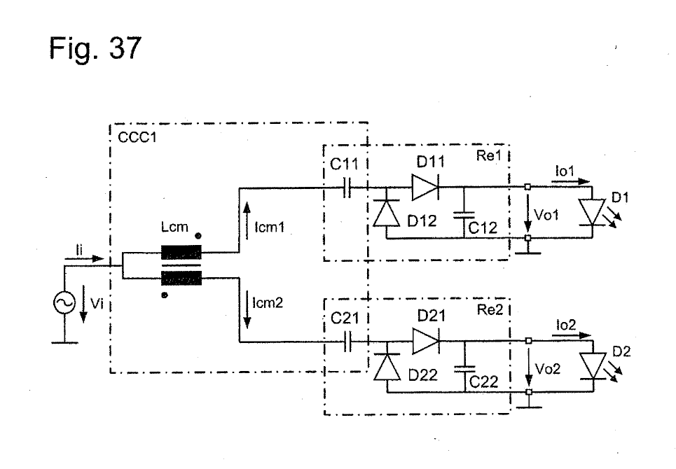

FIG. 37 shows the circuit according to FIG. 2 which likewise contains the resonant cell structure. This has been indicated for illustration and labeled CCC1.

As the circuits according to FIGS. 3 and 5 are based on the same circuit principle, they also contain the corresponding configuration.

Other examples of converters containing such a configuration are the half-bridge converter in FIG. 8d and the class E converter in FIG. 8e.

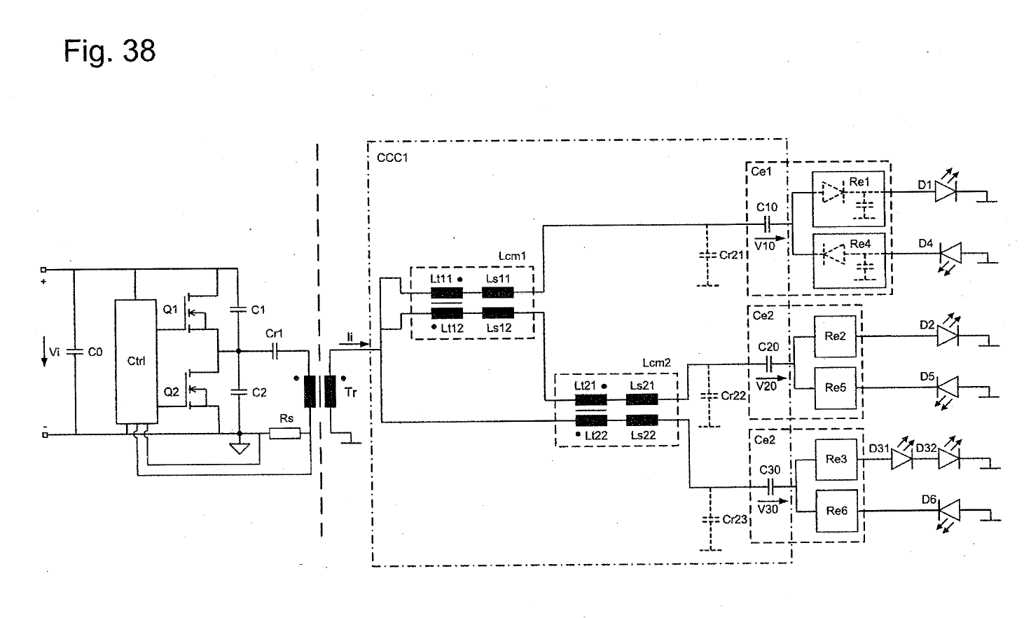

FIG. 38 shows a ZVS half-bridge converter which uses the leakage inductances of the common mode chokes as resonant inductance.

The following figures consider another variant of current balancing of a plurality of light emitting diode strings using multiresonant cell converters.

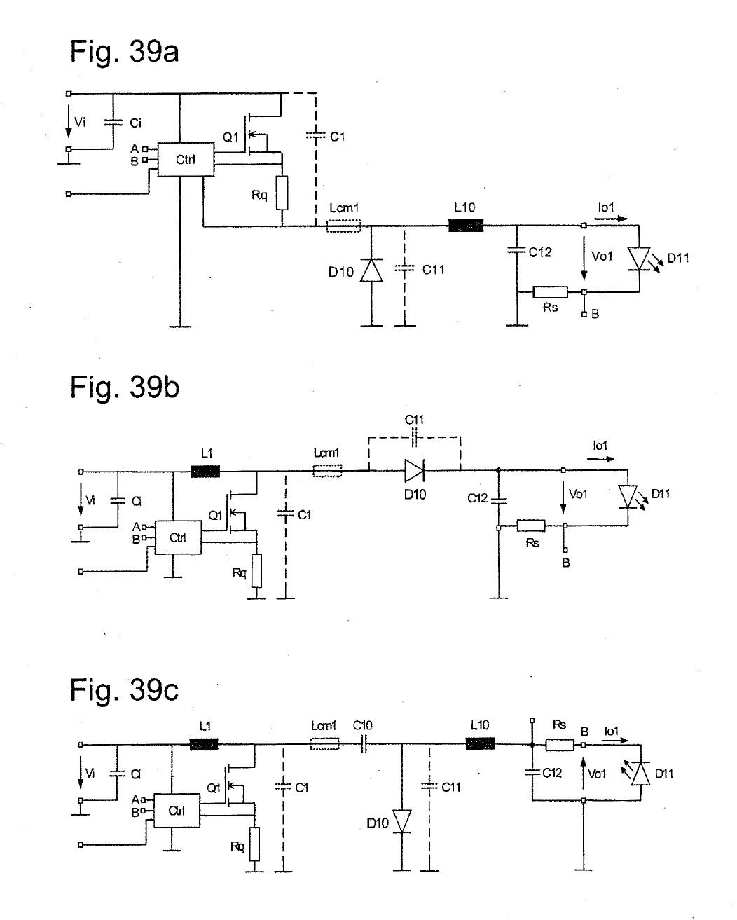

FIGS. 39a, 39b and 39c show the basic circuitry of a step-down or buck converter (FIG. 39a), a step-up or boost converter (FIG. 39b), and a Ćuk converter (FIG. 39c). Unlike the first two converters, the latter can produce output voltages whose absolute value can be less than or greater than its instantaneous input voltage. All three topologies belong to the single-switch DC/DC converter group. Illustrated in each case is the hard switching variant thereof, the inverter switches of which are controlled using known pulse width modulation techniques. Not shown in detail are the control of the inverter switch Q1 or S1 and the controller structure which feeds back particular output variables for controlling the inverter. The current measuring resistor RS is indicated.

Additionally indicated by dashed lines are the positions (C1, Lcm1, C11) where the (at least) three resonant elements must be inserted in order to change the above hard-switching basic topologies into their double zero-voltage switching (double ZVS) multiresonant equivalents. Equivalents because a multiresonant buck converter can only step down, a multiresonant boost converter can only step up and a multiresonant Ćuk converter can do both. Such circuits are particularly useful if unavoidable leakage inductances are present while at the same time high efficiency, high component density and good electromagnetic compatibility are required: the leakage inductances constitute the inductive part of a resonant circuit which is tuned to the operating frequency.

Each common mode choke also has an uncompensated leakage component, the fact on which the invention is based. In order to further develop the circuit arrangement according to FIG. 39c for a plurality of light emitting diode strings, the common mode choke must be inserted where the Ćuk converter requires an inductor as a prerequisite for zero voltage switching, i.e. at the location of the choke Lcm1, for example.

According to the invention, the leakage inductances of the at least one common mode choke are used to produce resonant circuits which allow the power switches within the converter circuits to be soft-switched.

Proposed is quasi-parallel operation of a plurality of light emitting diodes and/or of a plurality of light emitting diode strings using a converter which only has one inverter, and wherein all the light emitting diodes carry the same current. Control action only has to be applied to the current in one light emitting diode or in one string of light emitting diodes.

The above mentioned common inverter here basically comprises a single power switch and at least one storage inductor. The power switch can contain an uncontrolled antiparallel diode (inverse diode), and is controlled using special variable-frequency and state-dependent PWM. The above mentioned common mode choke is expressly not to be regarded as a storage inductor. Therefore, all six known single-switch DC/DC converters, namely the buck, boost, buck-boost, Ćuk, Zeta and SEPIC converter, can be used as basic converter topologies.

The plurality of rectifiers according to the invention contain as many diodes as light emitting diode strings present, i.e. precisely N rectifier diodes are provided for N light emitting diode strings. The number of the already mentioned storage inductors in buck, boost or buck-boost topologies is likewise precisely N, in Ćuk, SEPIC or Zeta topologies N+1. Their inductance values in the multi-output converter considered are approximately the same. In contrast to many special single-switch DC/DC converters, e.g. those with input or output ripple current compensation, none of these storage inductors needs to be coupled to one of the other storage inductors in the case of the inherently current balancing multi-output converters presented here.

Unlike the above embodiments, all the converters presented here operate in “double ZVS multiresonant conduction mode” in all their branches. The advantage of this mode of operation is the resonant soft-switching of all the switching edges of all the rectifier diodes involved and of the turn-on edge of the inverter switch. In addition, in the case of the three converters with current output (buck, Ćuk and Zeta) for supplying light emitting diodes, the otherwise usual output filter capacitor can be omitted, which in particular facilitates the controllability of a possible higher-order lighting system.

The resonant cells explained above play a key role here. If N inherently current balancing outputs are provided, the resonant cell comprises in addition to the at least one common mode choke at least N capacitors in series with the terminals of the common mode choke.

According to the invention, the common mode choke is always inserted where the additional resonant inductance is connected for converting a hard-switching CCM converter into a multiresonant double ZVS single-switch converter. The series capacitors required to the left or right thereof are either already present in the converter topology provided, or are likewise inserted as N resonant capacitors each connected in parallel with one of the N rectifier diodes. Although not directly visible, the series connection with the common mode choke is also preserved in this configuration. The capacitance of these N new “rectifier capacitors” is approximately equal in each case. Finally, yet another resonant capacitor, the so-called inverter capacitor, is connected in parallel with the inverter switch. The capacitance ratio of said inverter capacitor to the sum of all the N rectifier capacitors constitutes an important design criterion for these multiresonant converters.

In the case of N rectifier diodes within the considered converter topologies for N current balancing outputs, at least N storage inductors are always present—as already described above. In addition, a corresponding number of blocking or filter capacitors are always used which can then also be differentially charged to the different output voltages for each branch. As the respective output voltage is reflected in the reverse voltage of the associated rectifier diode, in addition to the freedom of being able to have an independent capacitor charged individually for each output branch, the “AC voltage elasticity” due to at least N independent storage inductors is the second basic requirement for inherent current balancing in the multiresonant single-switch DC/DC converters. Since, similarly to the rectifier diodes, the voltage across these storage inductors can be different for each branch, said storage inductors, as already explained, must be neither coupled to one another nor to any input storage inductor present.

This produces soft-switching converters in which both the switch S and the diodes are soft-switched, preferably zero-voltage switched in both cases. This results in a reduction in the losses, in particularly the switching losses, much less electromagnetic interference, and, because of the smaller EMC filters required, a higher overall efficiency of the circuit in question. Because of the greatly reduced switching losses, these converters can be operated at higher switching frequencies, which in turn leads to a reduction in the size of the energy storage devices, i.e. the inductors and capacitors, and therefore makes more compact converters possible. In contrast to the pulse width modulated converters which constitute their starting point, the multiresonant converters are operated not with constant frequency but with variable frequency for controlling the output power, which in turn helps to improve their EMC.

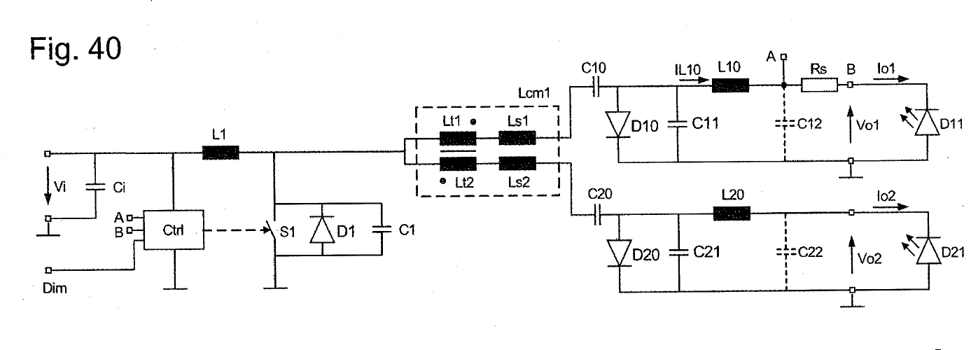

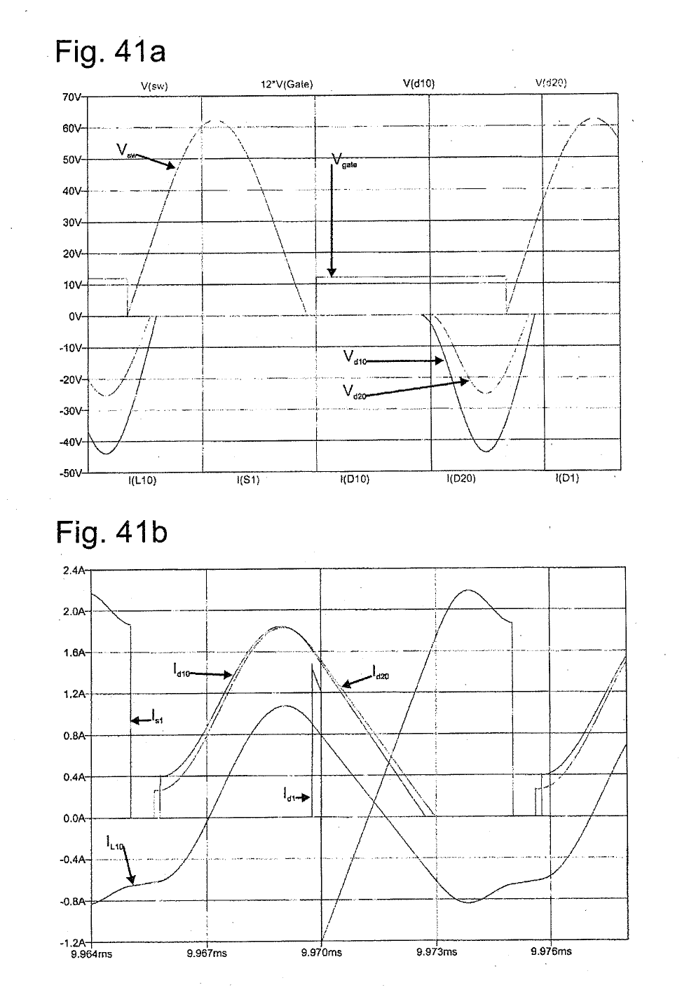

FIG. 40 shows a multiresonant Ćuk converter that has been enhanced as described above. Here the circuit according to FIG. 39c has been augmented by the resonant elements C1, C11 and C21 which are connected in parallel with the zero-voltage-switched switch S and the diodes D10 and D20. The inductances for the resonant circuits, which accomplish the soft switching, are implemented as a common mode choke in the form of the two leakage inductances Ls1 and Ls2. The blocking capacitors C10 and C20 together with Lcm1 form a resonant cell. The following table shows a typical dimensioning and the operating data which corresponds with the current and voltage waveforms according to FIG. 3:

| Ci | 10 | μF |
|---|---|---|
| L1 | 500 | μH |
| S1, D1 | IRFR120N (MOSFET and its body diode) | |
| C1 | 50 | nF |
| Lcm1 | Lt1 = Lt2 = 10 mH, Ls1 = Ls2 = l0O uH | |
| C1O, C20 | 10 | μF |
| D10, D20 | Schottky diode SS36 | |
| L10, L20 | 100 | μH |
| C11, C12 | 8 | nF |
| C12, C22 | 10 | μF |

| | |
|---|---|
| D11 | a white LED, OSRAM Dragon type |
| D21 | series circuit two white LEDs, type as D11 |

Operating data of Ćuk converter

| Vi | 18 | V |
|---|---|---|
| f | 100 | kHz |
| D | 50% | |
| Io1 | −737 | mA |
| Io2 | −743 | mA |

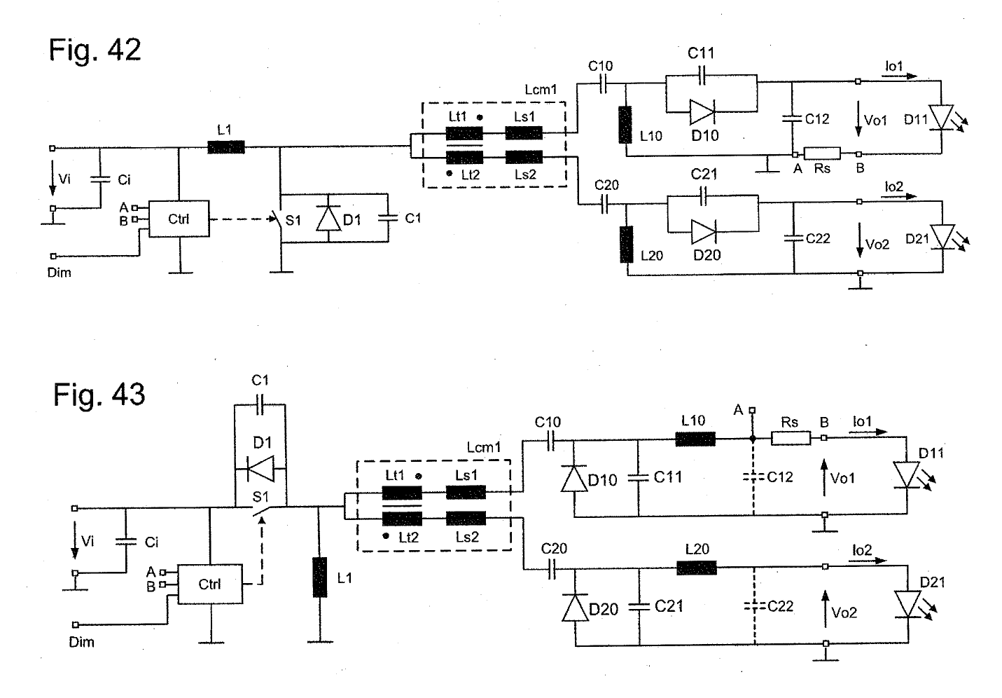

According to single-switch DC/DC converter theory known since 1988, the external variables and all the current and voltage behaviors inside the so-called converter cell (comprising S1, D1, C1, Lcm1, D10, C11, D20, C21) of a Ćuk converter are approximately identical to those of a buck-boost, SEPIC or Zeta converter if said converter cell is of the same design and S1 is controlled in like manner. Separate dimensioning and simulation of these three other topologies (see FIGS. 42, 43 and 48) can therefore be dispensed with.

This converter theory also makes it possible to calculate the external variables of a purely step-down or a purely step-up converter in the case of identical design of said converter cell and approximately identical behaviors over time in that converter cell. The following table shows the corresponding results for the so-called “identical cell” buck and boost converters. Here the output voltages of the buck converter correspond to those of the Ćuk converter, but at higher LED currents and higher input voltage. In the multiresonant boost converter, the input voltage and the average LED currents coincide with those of the Ćuk converter, although such a step-up converter then produces on average 24V at its outputs.

Operating data, buck, multiresonant

| Vi | 24 | V |
|---|---|---|
| F | 100 | kHz |
| D | 50% | |
| Io1 | 0.98 | A |
| Io2 | 0.94 | A |

Operating data, boost, multiresonant

| Vi | 18 | V |
|---|---|---|
| f | 100 | kHz |
| D | 50% | |
| Vo av. | 24 | V |
| Io av. | 740 | mA |

FIG. 42 shows a multiresonant SEPIC converter having two inherently balancing outputs. The corresponding multiresonant Zeta converter is shown in FIG. 43. For this purpose appropriate capacitors must be connected in parallel with all the switches (i.e. transistors and diodes) so that together with the leakage inductances of the common mode choke the resonant cell having the appropriate resonant circuits for soft switching is produced.

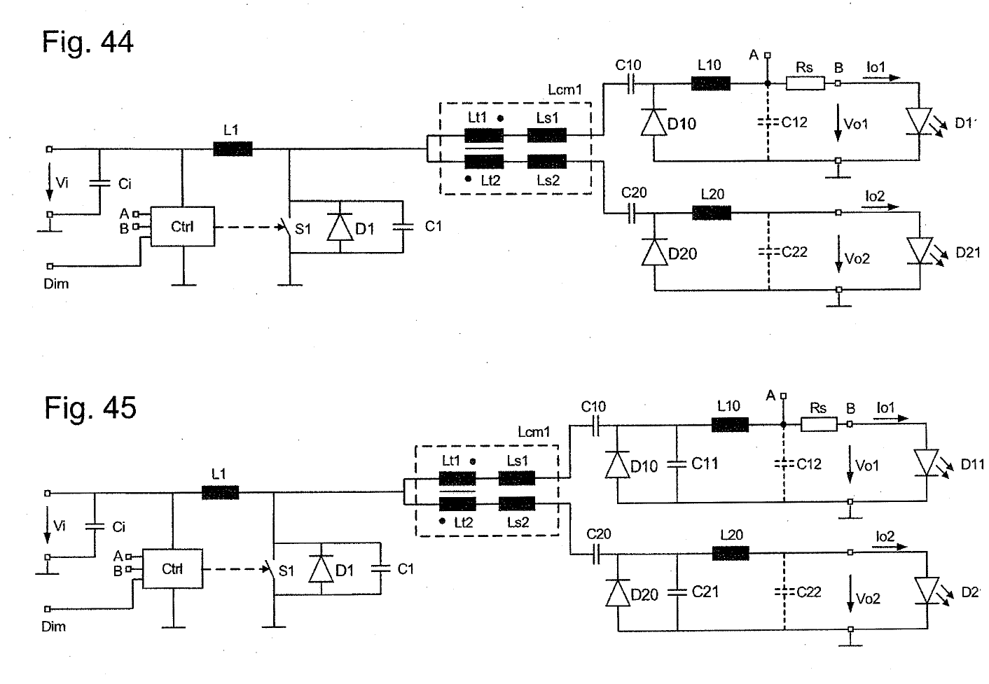

FIG. 44 shows a class E converter having hard-switching rectifier diodes at the output. These have likewise been converted into a corresponding multiresonant class E converter according to FIG. 45 by adding appropriate parallel capacitors.

Noticeable is the similarity between this FIG. 45 and FIG. 40: the only visible difference is the polarity of the rectifier diodes. In contrast to the Ćuk converter, in the class E converter the inverter capacitor C1 and a resonant matching network preceding the rectifier, which here consists precisely of the resonant cell, have always been fixed circuit constituents, for which reason rectification is always performed on an approximately ideal sinusoidal current, which can of course occur in both polarities. Not visible here is the fact that in the class E converter the capacitors C10 and C20 have much lower capacitance values than in the Ćuk converter, as in the former they are actually designed to operate as resonant elements, in the latter “only” as blocking capacitors.

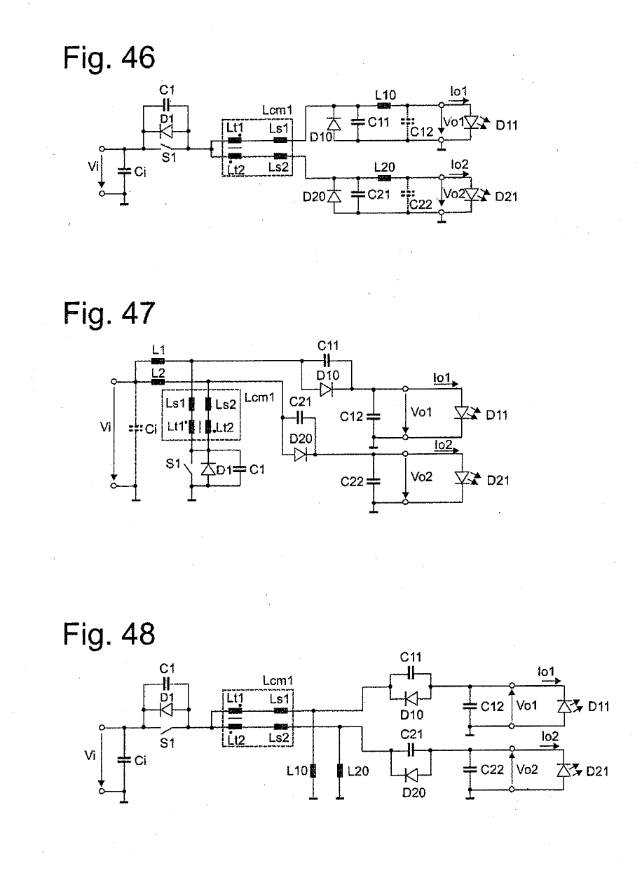

FIG. 46 shows the multiresonant, inherently current balancing buck converter or step-down converter, FIG. 47 the corresponding boost converter or step-up converter, FIG. 48 lastly the corresponding buck-boost converter.

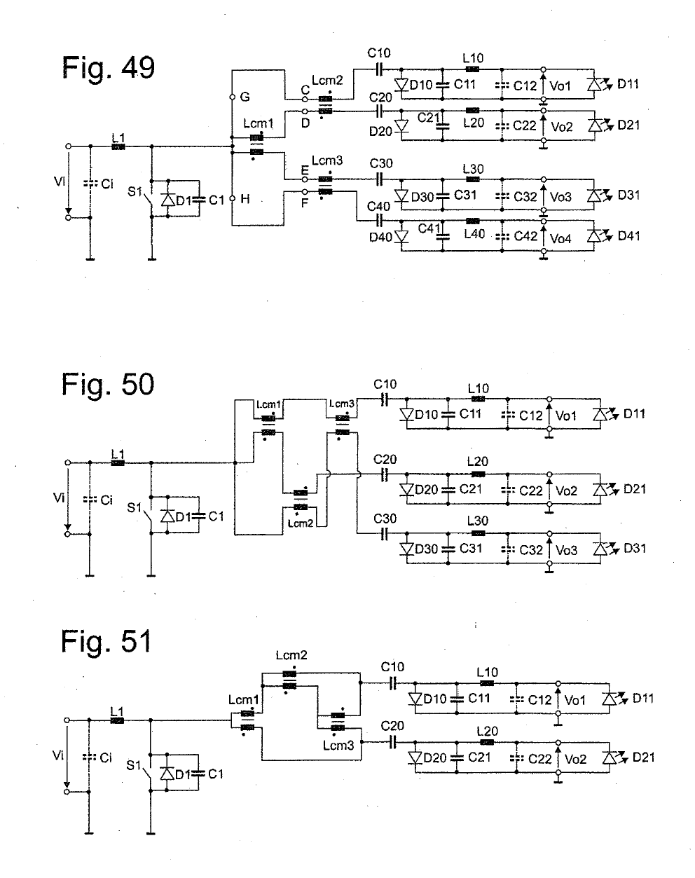

FIG. 49 shows a multiresonant Ćuk converter having 4 inherently current balancing outputs, with the three common mode chokes connected in a tree configuration. In the manner illustrated, the current load is equalized on average between Lcm1 . . . Lcm3, but the two middle output branches in each case “see” more series inductance than the two outer branches. This can be remedied by short-circuiting the points C and D and the points E and F, and by omitting the two connections between G and C and between H and F. However, it must then be taken into account that Lcm1 is confronted with twice the current load compared to the two downstream common mode chokes Lcm2 and Lcm3.

FIG. 50 shows a multiresonant Ćuk converter having three outputs, with the three common mode chokes connected in a symmetrical ring configuration, and FIG. 51 lastly shows a multiresonant Ćuk converter having two outputs and three common mode chokes that are connected such that the currents between output 1 and 2 are divided in the ratio 3:5. Here it should be noted that the current loads of the three common mode chokes Lcm1, Lcm2 and Lcm3 are in the ratio 4:2:1. The ratio between the capacitance values of C11 and C21 must likewise be 3:5, that between the capacitance values of the blocking capacitors C1O and C20 can be 3:5, that between the filter inductors L10 and L20 can conversely be 5:3. Without demonstrating this by further figures, it can nevertheless be stated that such comparatively complex balancing circuits can also be combined with one another, and that they are likewise transferable to the other topologies of FIGS. 42 to 48.

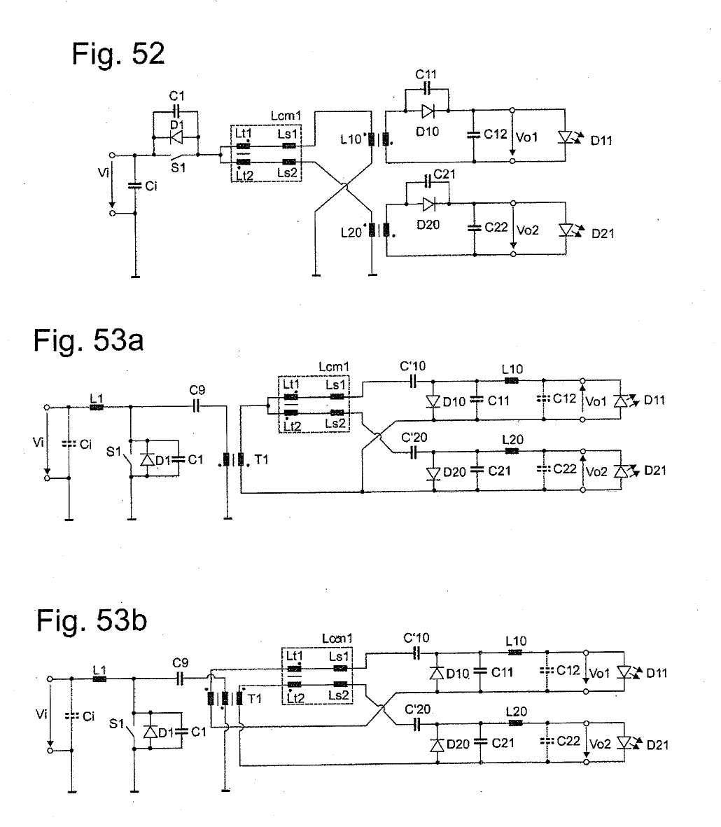

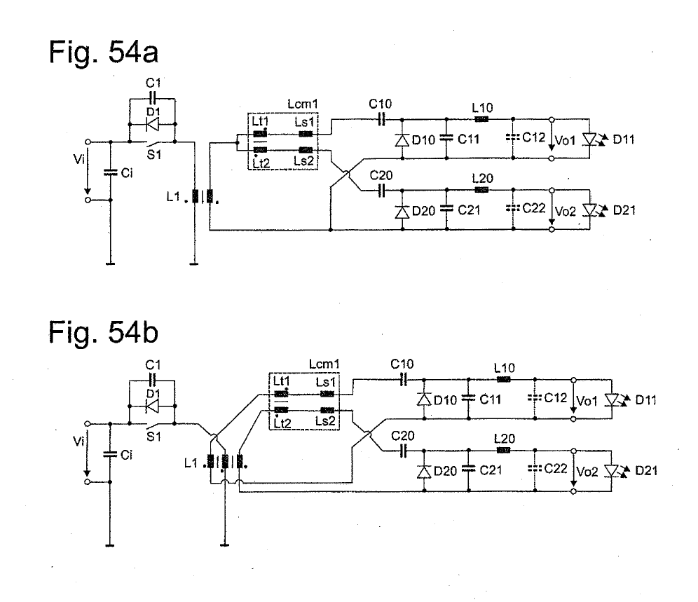

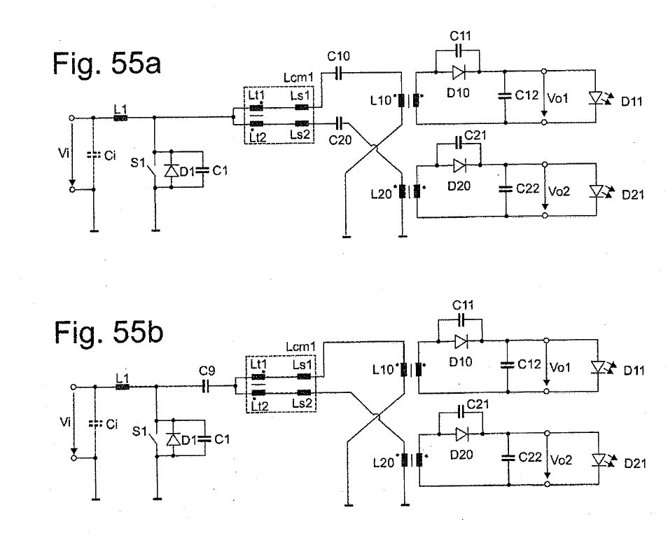

FIG. 52 shows the isolating variant of the buck-boost converter, the multiresonant inherently current balancing flyback converter. FIGS. 53a and 53b show corresponding Ćuk converters, FIGS. 54a and 54b isolating multiresonant Zeta converters, and FIG. 55 lastly the corresponding format of the SEPIC converter, shown with 2 outputs in each case. It is self-evident that in these topologies deliberately unbalanced outputs and/or more than 2 outputs as in FIGS. 49 to 51 are also possible in each case. Consciously disregarding the forward converter, which is often considered as an isolating buck converter, because, owing to its additional diodes, it is more a kind of “quarter bridge”, the buck and boost converters in their basic form are non-isolating. In the other four topologies, the leakage inductances of isolating transformers and common mode chokes are additive in their resonant inductance effect, thereby mitigating a basic problem of these multiresonant converters, namely that the “naturally” resulting leakage inductances are often too small. In the case of the need for a large average voltage transformation, the turns ratio in the isolating transformer may deviate from 1:1.

Because of its topological symmetry, the Ćuk converter according to FIGS. 53a and 53b assumes a special place: it can only be isolated by splitting its blocking capacitor C10, C20 into a primary-side C9 and the secondary-side C′10, C′20 and by inserting a transformer T1 precisely at this newly produced node. The two components C9 and T1 are therefore also newly added only in the Ćuk converter in its isolating form. Also, however, T1 has a purely AC load only at that point. Theoretically, SEPIC & Zeta can be isolated in precisely the same way. In the case of the SEPIC, however, a circuit comprising transformer secondary winding, blocking C and storage inductor would then be produced. In terms of its effect, such a circuit “degenerates” into a 2-winding storage inductor and a recombined blocking C on the primary side. In the case of the Zeta, a similar process occurs, except that the primary and secondary sides are transposed. In FIGS. 54 and 55, only these simplified topologies are therefore shown, and the isolating transformers bear the designations of the storage inductors of the original topologies from which they are derived.

For each of the 4 topologies, there are basically three isolating possibilities, as seen from the input in each case: if the common mode choke comes first, an independent isolating transformer is required for each output; the flyback and SEPIC converters according to FIGS. 52 and 55 are illustrated thus. If the common mode choke does not come until after the isolation line as shown with reference to the Ćuk and the Zeta, for example, a common isolating transformer suffices, in the case of common secondary potential using a secondary winding according to FIGS. 53a and 54a, in the case of complete isolation using an independent secondary winding for each output according to FIGS. 53b and 54b.

1. A circuit arrangement for operating at least two semiconductor light sources, having:
an electrical energy converter, comprising at least one switch, wherein the electrical energy converter outputs a pulsating DC voltage or an AC voltage;
at least two operating sections, each of which has a unidirectionally blocking or short-circuiting rectifier with an input terminal, an output terminal and a reference potential, wherein each rectifier contains a single rectifier diode, wherein the operating sections are coupled to the electrical energy converter;
at least one common mode choke, wherein the common mode choke is connected between the switch and the at least two rectifiers; and
at least two semiconductor light sources which are each connected between the output terminal of the associated rectifier and the reference potential thereof,
wherein the electrical energy converter is a resonant converter having a resonant cell, wherein a resonant capacitor is connected in parallel with each of the switches encompassed by the converter topology and to each rectifier diode encompassed by the converter topology, and wherein the leakage inductance of the common mode choke is used as the resonant inductance of said resonant cell.

2. The circuit arrangement as claimed in claim 1, wherein using the leakage inductance of the common mode choke, whenever the switch is non-conducting and at the same time at least one of the rectifier diodes is conducting, the resonant cell forms a closed series resonant circuit via said rectifier diode, whenever the rectifier diode is non-conducting and at the same time the switch is conducting, from the point of view of the rectifier the resonant cell forms a parallel resonant circuit, whenever both the switch involved and at least one of the rectifier diodes are non-conducting, the resonant cell forms a mixture thereof, and whenever both switches and rectifier diodes are conducting, the resonant cell forms a pure current-time integrator.

3. The circuit arrangement as claimed in claim 2, wherein the resonant cell has at least one capacitor which is connected to the reference potential.

4. The circuit arrangement as claimed in claim 1, wherein the electrical energy converter is a class E converter.

5. The circuit arrangement as claimed in claim 1, wherein the electrical energy converter is one of a buck converter, a boost converter, a buck-boost converter, a Ćuk converter, a SEPIC or a Zeta converter.

6. The circuit arrangement as claimed in claim 1, wherein the electrical energy converter is one of a buck-boost converter, a SEPIC or a Zeta converter, wherein the respective internal converter inductor thereof is replaced by a transformer, and wherein the leakage inductance thereof is used as resonant inductance and is added to the leakage inductance of the at least one common mode chokes in terms of its effect.

7. The circuit arrangement as claimed in claim 1, wherein the electrical energy converter is a Ćuk converter or class E converter, wherein the internal series capacitance thereof is augmented by an additional capacitor connected in series, wherein the node therebetween is opened, wherein a transformer is inserted there, and wherein the leakage inductance thereof is used as resonant inductance and is added to the leakage inductance of the at least one common mode chokes in terms of its effect.

8. The circuit arrangement as claimed in claim 8, wherein said transformer has as many secondary windings as there are operating sections in the circuit arrangement, wherein the reference potentials of the individual operating sections are not interconnected, and the isolating effect of the at least one common mode choke between its windings is jointly utilized.
